(19) United States
(12) Patent Application Publication
(10) Pub. No.: US 2026/0113529 A1
(43) Pub. Date: Apr. 23, 2026

(54) Stabilized Object Tracking At High Magnification Ratios

(71) Applicant: Google LLC, Mountain View, CA (US)

(72) Inventors: Suyao Ji, Mountain View, CA (US); Fuhao Shi, San Jose, CA (US); Chia-Kai Liang, Cupertino, CA (US); Arthur Kim, Brooklyn, NY (US); Gabriel Nava Vazquez, San Jose, CA (US)

(21) Appl. No.: 19/117,920

(22) PCT Filed: Oct. 4, 2022
(86) PCT No.: PCT/US2022/077510

§ 371 Date: Apr. 2, 2025

(51) Int. Cl. H04N 23/63; G06T 7/20; G06V 10/25; H04N 23/667

(52) U.S. Cl. CPC H04N 23/632; G06T 7/20; G06V 10/25; H04N 23/667; G06T 2207/30241

(57) ABSTRACT

An example method includes displaying, by a display screen of an image capturing device, a preview of an image representing a field of view of the image capturing device. The method includes determining a region of interest in the preview. The method includes transitioning the image capturing device from a normal mode of operation to a zoomed mode of operation. The zoomed mode of operation includes: determining, based on sensor data collected by a sensor associated with the image capturing device, a motion trajectory for the region of interest, and based on the determined motion trajectory, generating an adjusted preview representing zoomed portion of the field of view. The adjusted preview displays the region of interest at or near a center of the zoomed portion. The method includes providing the adjusted preview of the portion of the field of view.

### BACKGROUND

Many modern computing devices, including mobile phones, personal computers, and tablets, include image capture devices. Some image capture devices are configured with telephoto capabilities.

### SUMMARY

The present disclosure generally relates to stabilization of an image in a viewfinder of an image capture device at high magnification ratios. In one aspect, an image capture device may be configured to frame and track an object of interest in a narrow field of view resulting from a high magnification ratio. Powered by a system of machine-learned components, the image capture device may be configured to stabilize and maintain the frame.

In a first aspect, a computer-implemented method is provided. The method includes displaying, by a display screen of an image capturing device, a preview of an image representing a field of view of the image capturing device. The method also includes determining a region of interest in the preview of the image. The method further includes transitioning the image capturing device from a normal mode of operation to a zoomed mode of operation, wherein the zoomed mode of operation includes: determining, based on sensor data collected by a sensor associated with the image capturing device, a motion trajectory for the region of interest, and based on the determined motion trajectory, generating an adjusted preview representing a zoomed portion of the field of view, wherein the adjusted preview displays the region of interest at or near a center of the zoomed portion. The method additionally includes providing, by the display screen, the adjusted preview of the portion of the field of view.

In a second aspect, a device is provided. The device includes one or more processors operable to perform operations. The operations include displaying, by a display screen of an image capturing device, a preview of an image representing a field of view of the image capturing device. The operations also include determining a region of interest in the preview of the image. The operations further include transitioning the image capturing device from a normal mode of operation to a zoomed mode of operation, wherein the zoomed mode of operation includes: determining, based on sensor data collected by a sensor associated with the image capturing device, a motion trajectory for the region of interest, and based on the determined motion trajectory, generating an adjusted preview representing a zoomed portion of the field of view, wherein the adjusted preview displays the region of interest at or near a center of the zoomed portion. The operations additionally include providing, by the display screen, the adjusted preview of the portion of the field of view.

In a third aspect, an article of manufacture is provided. The article of manufacture may include a non-transitory computer-readable medium having stored thereon program instructions that, upon execution by one or more processors of a computing device, cause the computing device to carry out operations. The operations include displaying, by a display screen of an image capturing device, a preview of an image representing a field of view of the image capturing device. The operations also include determining a region of interest in the preview of the image. The operations further include transitioning the image capturing device from a normal mode of operation to a zoomed mode of operation, wherein the zoomed mode of operation includes: determining, based on sensor data collected by a sensor associated with the image capturing device, a motion trajectory for the region of interest, and based on the determined motion trajectory, generating an adjusted preview representing a zoomed portion of the field of view, wherein the adjusted preview displays the region of interest at or near a center of the zoomed portion. The operations additionally include providing, by the display screen, the adjusted preview of the portion of the field of view.

In a fourth aspect, a system is provided. The system includes means for displaying, by a display screen of an image capturing device, a preview of an image representing a field of view of the image capturing device; means for determining a region of interest in the preview of the image; means for transitioning the image capturing device from a normal mode of operation to a zoomed mode of operation, wherein the zoomed mode of operation includes: means for determining, based on sensor data collected by a sensor associated with the image capturing device, a motion trajectory for the region of interest, and based on the determined motion trajectory, means for generating an adjusted preview representing a zoomed portion of the field of view, wherein the adjusted preview displays the region of interest at or near a center of the zoomed portion; and means for providing, by the display screen, the adjusted preview of the portion of the field of view.

Other aspects, embodiments, and implementations will become apparent to those of ordinary skill in the art by reading the following detailed description, with reference where appropriate to the accompanying drawings.

### BRIEF DESCRIPTION OF THE FIGURES

FIG. 1 is a diagram illustrating an adjusted preview of a portion of a field of view, in accordance with example embodiments.

FIG. 2 is a diagram illustrating alert notification for stabilized object tracking, in accordance with example embodiments.

FIG. 3A is an example workflow for stabilized object tracking, in accordance with example embodiments.

FIG. 3B is an example workflow for applying a zoom stabilization, in accordance with example embodiments.

FIG. 4 is an example workflow for processing successive frames in a hybrid tracker, in accordance with example embodiments.

FIG. 5 depicts an example tracking optimization process, in accordance with example embodiments.

FIG. 6 depicts another example tracking optimization process, in accordance with example embodiments.

FIG. 7 depicts another example tracking optimization process, in accordance with example embodiments.

FIG. 8 depicts an example tracking optimization process for two regions of interest, in accordance with example embodiments.

FIG. 9 illustrates an example image with stabilized object tracking, in accordance with example embodiments.

FIG. 10 illustrates another example image with stabilized object tracking, in accordance with example embodiments.

FIG. 11 illustrates another example image with stabilized object tracking, in accordance with example embodiments.

FIG. 12 is a diagram illustrating training and inference phases of a machine learning model, in accordance with example embodiments.

FIG. 13 depicts a distributed computing architecture, in accordance with example embodiments.

FIG. 14 is a block diagram of a computing device, in accordance with example embodiments.

FIG. 15 depicts a network of computing clusters arranged as a cloud-based server system, in accordance with example embodiments.

FIG. 16 is a flowchart of a method, in accordance with example embodiments.

### DETAILED DESCRIPTION

Example methods, devices, and systems are described herein. It should be understood that the words “example” and “exemplary” are used herein to mean “serving as an example, instance, or illustration.” Any embodiment or feature described herein as being an “example” or “exemplary” is not necessarily to be construed as preferred or advantageous over other embodiments or features. Other embodiments can be utilized, and other changes can be made, without departing from the scope of the subject matter presented herein.

Thus, the example embodiments described herein are not meant to be limiting. Aspects of the present disclosure, as generally described herein, and illustrated in the figures, can be arranged, substituted, combined, separated, and designed in a wide variety of different configurations, all of which are contemplated herein.

Further, unless context suggests otherwise, the features illustrated in each of the figures may be used in combination with one another. Thus, the figures should be generally viewed as component aspects of one or more overall embodiments, with the understanding that not all illustrated features are necessary for each embodiment.

### Overview

This application relates to image stabilization using machine learning techniques, such as, but not limited to, neural network techniques. In the event a user of an image capturing device previews an image at a high magnification ratio, the resulting image may not be steady, and there may be challenges to framing an object of interest in the image. Also, for example, after framing the object of interest, the small field of view (FOV) resulting from the high magnification ratio may result in additional challenges to maintaining a moving frame in a smooth, continuous, and/or stable manner. As such, an image-processing-related technical problem arises that involves stabilizing the object of interest in the preview, and maintaining a smooth movement for the object of interest within a moving frame. Also, for example, an image-processing-related technical problem arises that involves smoothly transitioning an operation of the image capturing device between different modes (e.g., corresponding to different magnification ratios).

Telephoto cameras are becoming increasingly popular in flagship devices. Higher and higher optical zoom lenses combined with higher resolution image sensors have been used to boost the maximum magnification ratio in each successive release of a device. The image quality at high magnification ratios has continuously improved. However, the extremely narrow FOV at a high magnification ratio (e.g., FOV of approximately 1° at 80× magnification ratio) makes it challenging to frame an object of interest within the FOV, and it is especially challenging to maintain such a framing while simultaneously pressing the shutter button to capture an image. A ‘hide-and-seek’ game may result whereby a user attempts to find the object of interest in the narrow field of view. Although existing optical image stabilization (OIS) and/or electronic image stabilization (EIS) algorithms attempt to improve this situation to a limited extent, there remains residual motion which becomes magnified at higher magnification ratios.

For example, with an OIS limited to approximately ±0.9°, and without an EIS, it is likely that “what you see is what you get” (WYSIWYG); however, it may be challenging to maintain a region of interest (ROI) within the frame, and it may be challenging to find the ROI in a zoomed frame. Also, in the event an EIS (e.g., limited by noise due to a gyro and/or sensor) is applied, there may be a loss of the WYSIWYG feature, and a dragging effect may appear in the image. Thus, some smart devices configured with cameras attempt to solve this problem by reducing a maximum magnification ratio for a video mode as compared to a photo mode.

Generally, baseline EIS may compensate for hand-shake without a tracking capability. However, it may be challenging to maintain moving objects within the viewfinder under high magnification ratios. Also, for example, the trajectory of moving objects may not be smooth.

Gyro and/or OIS based EIS may be used in some situations as a stabilization technique. This stabilization technique is sensor based, such as gyro sensing and/or OIS sensing. Although this may compensate for camera pose change without dependency on image content, it may result in limiting the FOV of the output stabilized frame since the margin is used to generate the stable virtual pose. At high magnification ratios, hardware limitations such as gyro noise, OIS sensing noise, OIS calibration error, signal latency, and so forth may also introduce visible residual motions.

Some techniques may involve detecting a location of a face in addition to the EIS techniques described above. Although this approach may result in a stabilized frame along the face movement, this technique is limited to faces, and not general objects of interest. Also, like the EIS approach, it may result in limiting the FOV of the output stabilized frame since the frames are cropped after stabilization.

The techniques described herein address these challenges by enabling smooth photo and/or video capturing and easy framing experience at high magnification ratios. This is achieved by reliably tracking the ROI and locking it at or near the center of a viewfinder, or by maintaining a smooth movement within the frame. Gyro and/or OIS sensor information is used to determine a motion trajectory, but the image based ROI tracking effectively overcomes the hardware limitations (such as gyro noise, OIS sensing noise, OIS calibration error, signal latency, and so forth).

The herein-described techniques may include aspects of the image-based techniques in combination with techniques based on motion data and optical image stabilization (OIS) data. A neural network, such as a convolutional neural network, can be trained and applied to perform one or more aspects as described herein. In some examples, the neural network can be arranged as an encoder/decoder neural network.

This method is targeted at high magnification ratios, and utilizes the digital zoom crop margin for stabilization without any additional crop. The zoom stabilization pipeline may be configured to enable determination of a saliency map and object tracker with reference to the entire image sensor region, or the ROI center cropped sensor region, so that stabilization may be achieved along the ROI as long as it is located within the image sensor. As described herein, saliency detection, object tracking, as well as optical flow, are used to jointly propose a ROI to stabilize. Potential frame delay due to a camera pipeline depth (e.g. 5 frames) is also handled. Also described is a new user interface (UI) and/or user experience (UX) design that enables a frame-in-frame viewfinder in the event the zoom stabilization mode is active, and the bounding box moves relative to the frame to indicate a stabilized and enlarged FOV relative to the sensor area or the entire FOV. The techniques described also maintain the same FOV as defined by the user, without sacrificing additional margin to stabilize the frame.

In one example, (a copy of) the trained neural network to detect salient objects can reside on a mobile computing device. The mobile computing device can include a camera that can capture an input photo or video. A user of the mobile computing device can view the input photo or video and determine that an object in the input photo or video should be tracked. The input photo or video and motion data may be provided to the trained neural network residing on the mobile computing device. In response, the trained neural network can generate a predicted output that shows an ROI with a bounding box. In other examples, the trained neural network is not resident on the mobile computing device; rather, the mobile computing device provides the input photo or video and motion data to a remotely-located trained neural network (e.g., via the Internet or another data network). The remotely-located neural network can process the input photo or video and the motion data as indicated above and provide an output. In other examples, non-mobile computing devices can also use the trained neural network to stabilize object tracking in images and videos at high magnification ratios, including photos or videos that are not captured by a camera of the computing device.

As such, the herein-described techniques can improve image capturing devices by stabilizing images, and providing a zoomed-in view, thereby enhancing their actual and/or perceived quality. Enhancing the actual and/or perceived quality of photos or videos can provide user experience benefits. These techniques are flexible, and so can apply to a wide variety of videos, in both indoor and outdoor settings.

### Techniques for Image Stabilization Using Neural Networks

One of the main features of image stabilization is to maintain an accurate and reliable tracker for a region of interest (ROI). Minimizing tracking noise, and reducing noise due to gyro and/or OIS, can contribute significantly to image stabilization. Additional challenges include pose changes, occlusions, and objects moving in and/or out of the sensor region. There may also be latency issues related to delay between image processing at the hardware layer and the subsequent changes at the software or application layer. For example, the pipeline depth (e.g., five frames) may result in delays. For a mobile camera application, additional image crop may not be allowed in photo mode. Furthermore, stabilization needs to smoothly transition between multiple modes of the camera.

Accordingly, as described here, a zoom stabilization mode of a mobile device can capture a smooth photo and/or video at high magnification ratios by reliably tracking and locking a user's region of interest (ROI) (or object of interest) at the center of a field of view (FOV) or smoothly moving the ROI within the frame for easing framing experience of the user.

Noise from a gyro and/or OIS, or from calibration errors, may impact smooth tracking. There may also be challenges arising from complicated integration of a camera application with the underlying hardware layer, the saliency node, rectiface and/or EIS node, and so forth. Also, for example, the image quality can be low at a high magnification ratio, especially with a remosaic mode. Accordingly, the zoom stabilization mode may also be configured to support binning transition. In some embodiments, under bright light conditions (e.g., outdoors), the remosaic mode may result in higher image quality due to a higher resolution as compared to the binning mode. However, under low light conditions, given poor noise performance under remosaic mode, the binning mode may result in higher image quality.

As described herein, zoom stabilization can have several technical advantages, such as limited power and a low latency budget for real time photo preview. Zoom stabilization can also be configured for multi-object handling (e.g., animal herds). Also, for example, zoom stabilization is compatible with existing features (e.g., HDR+, Longshot video, and so forth).

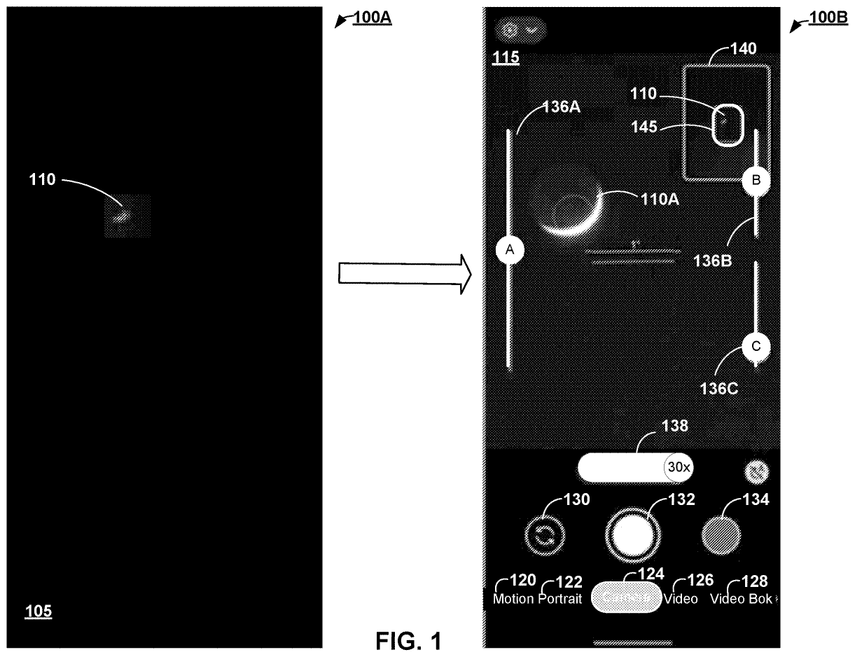

FIG. 1 is a diagram illustrating an adjusted preview of a portion of a field of view, in accordance with example embodiments. In some embodiments, a display screen of an image capturing device may display a preview of an image representing a field of view of the image capturing device. For example, display screen 100A may display a field of view 105 that may include an object of interest, such as an image of a crescent moon 110. While operating at a high magnification ratio for the image capturing device, the field of view 105 may be narrow, and small hand movements may cause the crescent moon 110 to fall out of the field of view 105.

Some embodiments involve determining a region of interest in the preview of the image. For example, there may be no ROI within the field of view, or the ROI may have moved out of the field of view. In such embodiments, background motion within the field of view may be tracked. In some embodiments, a new ROI may be detected within the field of view. For example, an ROI tracker may identify a new object. A significant feature of the ROI tracker is to reliably predict what a user of the camera is attempting to capture. This may be achieved individually, or a combination of, a user indication and a machine learning based algorithm. For example, a Tap ROI tracker in the camera application can enable a user to tap the display screen and indicate an object and/or region of interest. Also, for example, a saliency map may be generated using a machine learning model, where the saliency map indicates a region of interest for the user. Although existing saliency maps output a fixed-size bounding box for an ROI, zoom stabilization described herein is configured to estimate a size of the ROI and output an appropriate bounding box for the ROI. In some embodiments, confidence for an ROI may be low. In such embodiments, a background motion, a center ROI, or a combination of both, may be used to maintain smooth framing.

Some embodiments involve transitioning the image capturing device from a normal mode of operation to a zoomed mode of operation. For example, the image may be captured at different levels of zoom. At high magnification ratios, the field of view may be considerably narrower, and small movements of the camera may cause abrupt changes to the image being captured by the field of view. In some embodiments, a threshold magnification ratio may be used to determine whether image stabilization algorithms, such as the zoom stabilization algorithms described herein, may need to be turned on or off. For example, some cameras may be configured so that mode switching happens at a magnification ratio of 15×. For example, the zoom stabilization mode can be turned on for magnification ratios larger than 15×, and turned off for magnification ratios smaller than 15×. Additional, and/or alternative magnification ratios may be utilized.

In some embodiments, the zoomed mode of operation may involve determining, based on sensor data collected by a sensor associated with the image capturing device, an adjusted preview representing a zoomed portion of the field of view, where the adjusted preview displays the region of interest at or near a center of the zoomed portion. As illustrated in display screen 100B, field of view 105 may be displayed within a view bounded by an outer frame 140. An inner frame 145 may be displayed within the outer frame 140. Inner frame 145 may include the object of interest, the crescent moon 110. Accordingly, display screen 100B may display an adjusted preview 115 (e.g., an enlarged view) representing a zoomed portion (e.g., within inner frame 145) of the field of view (e.g., field of view 105 as displayed within outer frame 140). As illustrated, display screen 100B displays an enlarged view 115 of a portion of the field of view, including an enlarged view of the crescent moon 110A. To the extent that the image of the crescent moon 110 may display non-smooth motion within an original field of view 105, the inner frame 145 is a stabilized image, and the enlarged view 115 is a stabilized zoomed view of the crescent moon 110A.

Display screen 100B may include additional features related to a camera application. For example, multiple modes may be available for a user, including, a motion mode 120, portrait mode 122, video mode 126, and video bokeh mode 128. As illustrated, the camera application may be in camera mode 124. Camera mode 124 may provide additional features, such as a reverse icon 130 to activate reverse camera view, a trigger button 132 to capture a previewed image, and a photo stream icon 134 to access a database of captured images. Also for example, a magnification ratio slider 138 may be displayed and a user can move a virtual object along magnification ratio slider 138 to select a magnification ratio. In some embodiments, a user may use the display screen to adjust the magnification ratio (e.g., by moving two fingers on display screen 100B in an outward motion away from each other), and magnification ratio slider 138 may automatically display the magnification ratio.

As indicated, magnification ratio slider 138 may be at 30×. For a camera that is configured to switch modes at a magnification ratio of 15×, in the event the magnification ratio slider 138 moves beyond 15×, the camera may switch from normal mode to zoom stabilization mode, and image stabilization may be automatically activated. In such instances, an object of interest may be determined, and the enlarged view 115, outer frame 140, inner frame 145, and so forth may be displayed.

The camera application may also provide various user adjustable features to adjust one or more image characteristics (e.g., brightness, hue, contrast, shadows, highlights, global brightness adjustment for an entire image, local brightness adjustments for an ROI, and so forth). For example, in some embodiments, slider 136A may be provided to adjust characteristic A, slider 136B may be provided to adjust characteristic B, and embodiments, slider 136C may be provided to adjust characteristic C.

In some embodiments, the zoomed mode of operation may involve determining, based on sensor data collected by a sensor associated with the image capturing device, a motion trajectory for the region of interest, and based on the determined motion trajectory, generating an adjusted preview representing a zoomed portion of the field of view, wherein the adjusted preview displays the region of interest at or near a center of the zoomed portion.

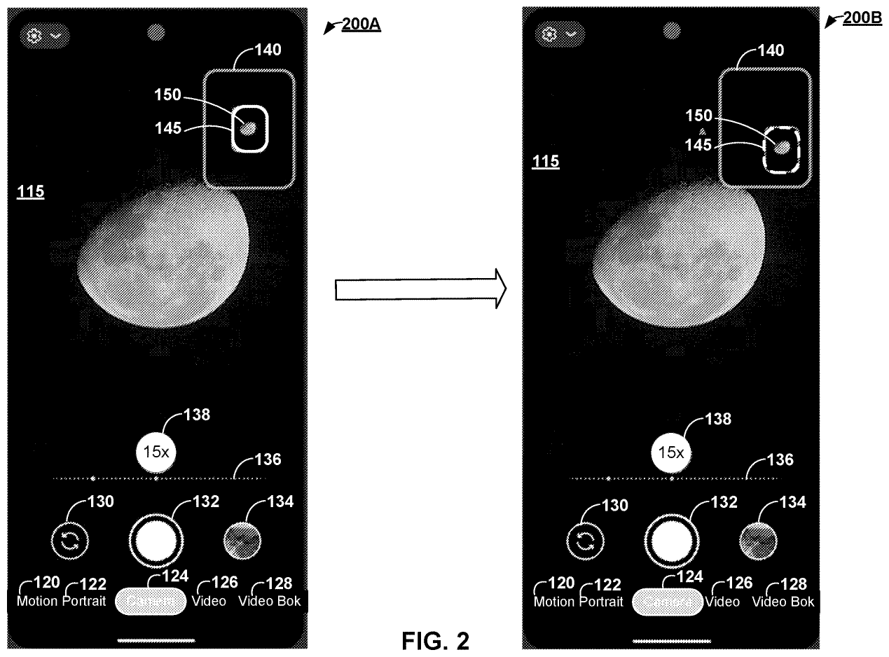

FIG. 2 is a diagram illustrating alert notification for stabilized object tracking, in accordance with example embodiments. Display screen 200A (res. display screen 200B) may include additional features related to a camera application. For example, multiple modes may be available for a user, including, a motion mode 120, portrait mode 122, video mode 126, and video bokeh mode 128. As illustrated, the camera application may be in camera mode 124. Camera mode 124 may provide additional features, such as a reverse icon 130 to activate reverse camera view, a trigger button 132 to capture a previewed image, and a photo stream icon 134 to access a database of captured images. Also for example, a magnification ratio slider 138 may be displayed and a user can move a virtual object along magnification ratio slider 138 to select a magnification ratio. In some embodiments, a user may use the display screen 200A (res. display screen 200B) to adjust the magnification ratio (e.g., by moving two fingers on display screen 200A (res. display screen 200B) in an outward motion away from each other), and magnification ratio slider 138 may automatically display the magnification ratio.

As indicated, magnification ratio slider 138 may be at 15×. For a camera that is configured to switch modes at a magnification ratio of 15×, in the event the magnification ratio slider 138 moves to 15×, the camera may switch from a normal mode to zoom stabilization mode, and image stabilization may be automatically activated. In such instances, an object of interest may be determined, and the enlarged view 115, outer frame 140, inner frame 145, and so forth may be displayed. The zoom ratios are for illustrative purposes only, and may differ with device, and/or system configurations.

At high magnification ratios, operating a camera to track a moving object may cause pause-movement-pause type of motions, resulting in large residual motions with traditional EIS. This may be caused, for example, by a protrusion term, E_{Protrusion}, as described in Eqn. 1 below. Some embodiments include providing, by the display screen, an image overlay that displays a representation of the zoomed portion relative to the field of view. For example, a frame-in-frame feature stabilizes the image and guides the user. Some embodiments include determining a bounding box for the region of interest, and wherein the providing of the image overlay comprises providing the region of interest framed within the bounding box. As illustrated, display screen 200A displays a field of view within outer frame 140, and inner frame 145 within outer frame 140 frames the ROI, an image of the moon 150. An adjusted preview, such as enlarged view 115, corresponding to inner frame 145, is displayed with an enlarged view of the moon 150. As illustrated, the image of the moon 150 is centered within inner frame 145.

Some embodiments include detecting that the region of interest is approaching a boundary of the image overlay. For example, as the camera moves, and/or due to motion of the object, the image of the moon 150 may move within the field of view. In such embodiments, the zoom stabilization mode is able to maintain a stabilized enlarged view 115 with the image of the moon centered within the enlarged view 115. In some embodiments, the motion of the camera, and/or the object of interest may cause the object of interest to approach the boundary of inner frame 145, as illustrated in display screen 200B. Although the image of the moon is centered within enlarged view 115, the image may be closer to the boundary of inner frame 145.

Such embodiments also include providing a notification to the user indicating that the region of interest is approaching the boundary of the image overlay. For example, the boundary of inner frame 145 may turns red, may begin to flash, the device may vibrate, an audio notification may be provided, a voice instruction may be generated, an arrow may be displayed that indicates a direction of movement for the camera to maintain the image of the moon away from the boundary of the image overlay. Accordingly, the frame-in-frame may be configured to guide the user to find their object of interest, and the zoom stabilization mode may be configured to issue a notification to the user in the event the object of interest is closer to the boundary.

Generally, inner frame 145 may be configured to slide automatically with a movement of the object with the field of view, to detect and track the salient object without a user having to center the object. In some embodiments, the zoom stabilization algorithm may stabilize and track the object, while maintaining it at or near a center of the enlarged view 115. Generally, although outer frame 140 displays the field of view 105, the region defined by inner frame 145 can be cropped and displayed as an enlarged view 115. As described herein, an object of interest can be identified and tracked, and an inner frame 145 can be determined and cropped to generate the enlarged view 115, where zoomed in view of the object of interest is displayed at or near the center of the enlarged view 115, while maintaining a stabilized image with smooth movements. Accordingly, the object of interest can be locked at or near the center, or may be displayed as smoothly moving within the frame. Generally, the object of interest is locked at the center in the event the ROI is static, and/or is moving at a constant speed. In some embodiments, the motion trajectory for the region of interest is indicative of a variable speed of movement between successive frames. In such embodiments the adjusting of the preview includes maintaining, between the successive frames of the preview, a smooth movement for the region of interest at or near the center of the zoomed portion. For example, the object of interest is displayed as smoothly moving within the frame when the ROI moves at a variable speed. The smooth movement tracks the ROI as it moves. Such an approach enables high zoom photo and/or video without having to mount on a tripod.

Generally, a relative position of the image of the moon 150 stays stable within the enlarged preview 115, while the frames 140 and 145 track the moon, and so the preview displayed to the user is well centered and/or the moon moves smoothly and stays relatively stable inside the frames 140 and 145. This is a significant improvement to the display functionality of the image capturing device in that the stabilized image of the moon can potentially move out of the enlarged preview 115, and when the user attempts to move the device to manually track the moon, the moon may disappear out of the field of view. However, zoom stabilization algorithms are able to track the moon and alert the user when the moon is at or near the boundary of inner frame 145. This is especially useful at high magnification ratios because the preview FOV can be very narrow. For example, at 30×, an object of interest may easily move out of the preview, and zoom stabilization tracking is able to detect the object of interest, frames it, tracks it smoothly, and also alerts the user.

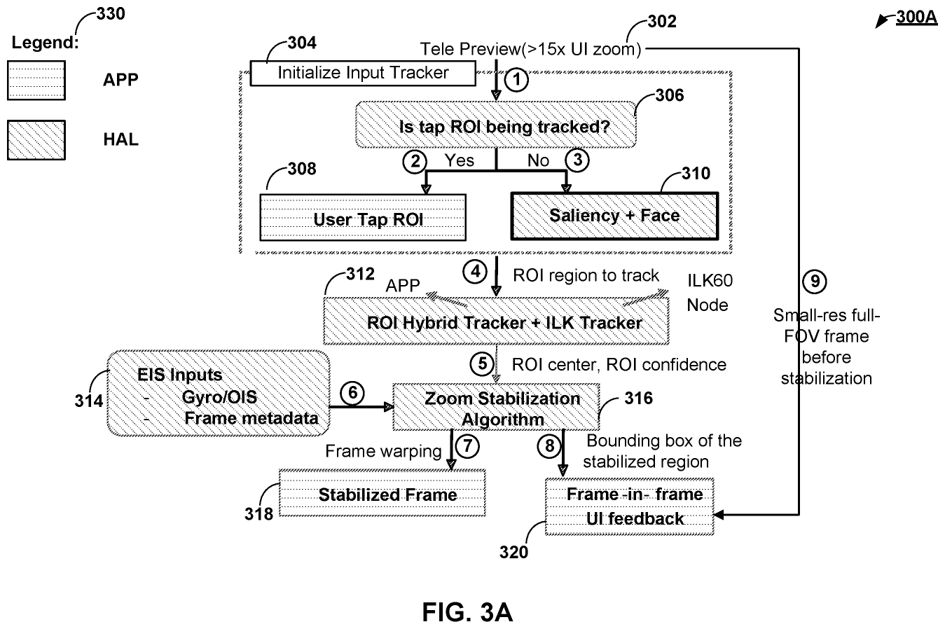

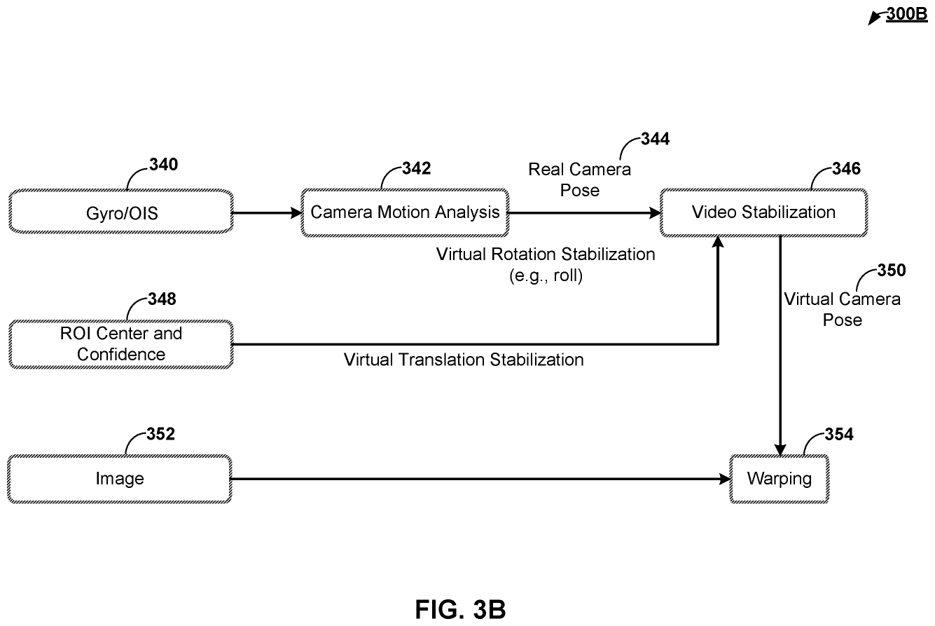

FIG. 3A is an example workflow 300A for stabilized object tracking, in accordance with example embodiments. Some image capturing devices include a hardware abstraction layer (HAL) that connects the higher level camera framework application programming interfaces (APIs) in a camera application (APP) layer into the underlying camera driver and hardware.

At 302, a tele-preview (or the zoom stabilization mode) may be activated in the event the magnification ratio exceeds a threshold magnification ratio (e.g., 15×). The zoom ratios are for illustrative purposes only, and may differ with device, and/or system configurations.

At 304, an input tracker may be initialized. At step 1, the system may move to block 306 to determine whether a Tap ROI is being tracked. In some embodiments, the determining of the region of interest includes receiving a user indication of the region of interest. At step 2, the system may determine that the Tap ROI is being tracked, and at block 308, a user indication of an ROI may be detected, and an initial ROI center may be extracted from the user tap.

At step 3, the system may determine that the Tap ROI is not being tracked. Some embodiments include generating the saliency map by a neural network. For example, at block 310, a saliency detection algorithm, and/or a face detection algorithm may be activated to identify an ROI. For example, at block 310, a machine learning (ML) based saliency map may be determined in the event a user tap is not detected. Saliency may be directly applied to the sensor region without further cropping. This allows new salient ROI detection that is potentially outside the user's final zoomed FOV. The algorithm may then extract the initial ROI center from the ML based saliency map. In some embodiments, the system may estimate the ROI size by motion vectors from the adjacent frames.

In some embodiments, the algorithm tracks the ROI by: (i) a combination of motion vector and an optical-flow, or (ii) using an ML hybrid tracker. The motion vector process may provide a better accuracy in the event the ROI transform is rigid without occlusion, and the hybrid tracker may be more reliable in the event the transform is non-rigid or occlusion occurs.

In some embodiments, the hybrid tracker uses the ROI center cropped frame to make the ROI trackable after downsizing. In some embodiments, the crop ratio may be set to a target digital magnification ratio, and/or a slightly smarter ratio that maintains the ROI within the cropped frame. The process then proceeds, at step 4, to the ROI region to be tracked.

At block 312, the hybrid tracker may jointly stabilize the ROI using a combined saliency detection, object tracker and optical flow to obtain a reliable and accurate ROI. The algorithm uses a non-hybrid tracker if a delta difference for the ROI center between the hybrid and non-hybrid tracker is small, and can use additional weights to smoothly weigh in the hybrid tracker if the delta difference between two trackers is large. Generally speaking, the non-hybrid tracker, or TLK tracker, uses a motion vector map (similar to the one for optical flow, but with a patch size of 64×64), to find a shift in the ROI between adjacent frames. The term “ILK” as used herein, generally refers to an inverse search version of the Lucas-Kanade algorithm for optical flow estimation. The term “ILK tracker” refers to an optical flow based tracker. The joint stabilization leads to the stabilization of potential frame delay due to the camera pipeline depth (e.g. 5 frames). For example, information from the hybrid tracker may be combined with the motion vectors from TLK to predict the ROI. This resolves the potential frame delay due to the camera pipeline depth. The process then proceeds, at step 5, to determine the ROI center and the ROI confidence.

At block 314, EIS inputs, such as gyro and/or OIS data, and frame metadata is provided to the zoom stabilization algorithm. For example, real time filtering and light weight optimization is performed to stabilize the frame with gyro and/or OIS data and ROI inputs. The process then proceeds, at step 6, to the zoom stabilization algorithm 316.

At block 316, the algorithm may generate a stabilized frame with EIS inputs (e.g., gyro sensor, OIS sensor, etc.) based on real time filtering and light weight optimization, and obtains the motion trajectory while overcoming hardware limitations (such as gyro noise, OIS sensing noise, OIS calibration error, signal latency, etc.). In some embodiments, the small resolution full sensor frame, stabilized frame center coordinates, and crop ratio may be provided to the user interface to generate the frame-in-frame viewfinder, as previously described.

FIG. 3B is an example workflow 300B for applying a zoom stabilization, in accordance with example embodiments. In particular, the features of zoom stabilization algorithm 316 of FIG. 3A is described herein. The zoom stabilization algorithm is based on the following relations:

$$arg {min}_{{w}_{i} , {o}_{j}} {w}_{0} {E}_{RotationalSmoothness} + {w}_{1} {E}_{TranslationalSmoothness} + {w}_{2} {E}_{ROI Center} + {w}_{3} {E}_{Protrusion} + {w}_{4} {E}_{follow real pose} + other terms \qquad ( Eqn . 1 )$$

Gyro/OIS noise 340 is provided to camera motion analysis 342. Camera motion analysis 342 may determine a motion trajectory for the region of interest. For example, spatial information about a location of one or more objects of interest (e.g., a face, a bounding box, etc.) may be extracted from each captured image frame. Some embodiments include determining a motion vector associated with a previous image frame and a current image frame. For example, a motion vector may be generated from the spatial information by taking an average of two adjacent frames. For example, a motion vector can be extracted between successive frames at every 64×64 patch. This results in an enhanced tracking capability.

For magnification ratios beyond a threshold value (e.g., 15×), a user tap indicating an ROI may be prioritized over an automatic tracking. In the absence of a user tap, the system may use a face detection algorithm to detect a face or a saliency model to detect an object of interest. In the absence of a face or an object of interest, the motion vector may be based on a center of the frame. The motion vector between a previous frame and a current frame is determined to obtain an approximate model for frame by frame movement.

The motion vector information may be combined with an output of the saliency model or the face detection model to determine the tracking for the object of interest. For example, a real camera pose 344 is provided to video stabilization 346. This process controls virtual rotation stabilization (e.g., roll of the camera). For example, the term argmin_{w}_{ᵢ}_{,o}_{ⱼ} w₀E_{RotationalSmoothness} reduces pitch/yaw weights to make it less sensitive to gyro noise. Also, for example, the term w₁E_{TranslationalSmoothness} reduces weights to make it less sensitive to OIS noise.

Also, for example, ROI Center and confidence 348 provides the virtual translation stabilization to video stabilization 346. The term w₂E_{ROI center} is introduced to stabilize the ROI at the center. The term w₃E_{Protrusion} corresponds to a pause-movement-pause type of motions, resulting in large residual motions with traditional EIS. Based on the real camera pose 344, an actual ROI position may be determined, and optimization can be performed based on the combined image information. Based on the input from the camera motion analysis 342 and the ROI Center and confidence 348, video stabilization 346 provides the virtual camera pose 350 to warping block 354. Image 352 is also provided to warping block 354.

Referring again to FIG. 3A, at step 7, frame warping from zoom stabilization algorithm 316 is used to generate stabilized frame 318. Also, at step 8, a bounding box of the stabilized region is provided to frame-in-frame UI feedback 320. Center cropping may be performed on the frame in the event no reliable ROI is available from the previous frame. Otherwise, ROI-centered cropping is performed.

At step 9, the algorithm provides the small resolution full sensor frame (prior to stabilization) to block 320. At block 320, the algorithm provides the small resolution full sensor frame, stabilized frame center coordinates, and the crop ratio to the UI to generate the frame-in-frame viewfinder to enable dynamic preview bounding box visualization.

Generally, a non-hybrid tracker may result in better accuracy. A hybrid tracker may provide a better trade-off between occlusion handling and accuracy. In some embodiments, the non-hybrid and hybrid tracker may be combined to achieve an optimally reliable and accurate ROI.

To maintain a stabilization quality, gyro and/or OIS noise that scales up with magnification ratio may be suppressed, and rotational effect correction, seamless transition, and so forth, may be achieved.

In the event a preview includes multiple objects, a most salient object among the objects may be identified. For example, with multiple objects in the preview, attention may be focused on one object, instead of switching between the multiple objects. For example, face detection type matching may be performed to identify a face of interest among several faces in an image. Also, for example, a saliency score may be generated by a machine learning model (e.g., visual saliency model) for multiple candidate salient objects detected in an image. The zoom stabilization algorithm may select an object with a high saliency score as the salient object. The saliency model may be trained on training data that indicates user interest and/or preference, and the trained saliency model can predict an object of interest to the user.

For example, a visual saliency model may be trained based on a training dataset comprising training scenes, sequences, and/or events. For example, the training dataset may include images (e.g., digital photographs), including user-drawn bounding boxes containing a visual saliency region (e.g., a region wherein one or more objects of particular interest to a user may reside). Based on the training dataset, the visual saliency model can predict visual saliency regions within images. For example, as a result of the training, the Visual saliency model can generate a visual saliency heatmap for a given image and produce a bounding box enclosing the region with the greatest probability of visual saliency (e.g., highest saliency score). One or more processors may calculate the visual saliency heatmap in the background operations of the device. In some embodiments, the visual saliency heatmap may indicate a magnitude of the visual saliency probability on a scale from black to white, where white indicates a high probability of saliency and black indicates a low probability of saliency.

In some embodiments, the visual saliency heatmap includes a bounding box enclosing the region within the image containing the greatest probability of visual saliency. In the event that there are multiple objects of interest in a photographic scene, causing the visual saliency model to identify multiple saliency regions within a captured image, the visual saliency model can be trained to produce a bounding box enclosing the saliency region nearest the center of the captured image. This trained technique assumes that a user is interested in the most centralized object in the image. Alternatively, the visual saliency model can be trained to produce a bounding box enclosing all the objects of interest in a captured image.

The image capturing device may perform operations under the direction of an Automatic Zoom Manager that implements various aspects of the zoom stabilization mode. In some embodiments, either automatically or in response to a received triggering signal, including, for example, a user performed gesture (e.g., tapping, pressing) enacted on the input/output device, the Automatic Zoom Manager may implement several steps that calibrate the image capturing device. For example, the Automatic Zoom Manager may receive one or more captured images from an image sensor of the image capturing device, and utilize the visual saliency model to generate a visual saliency heatmap using the one or more captured images. The visual saliency model may also output a bounding box enclosing the region with the greatest probability of visual saliency.

In the event that there are multiple objects of interest in the preview, causing the visual saliency model to identify multiple saliency regions within the preview, the visual saliency model can be trained to produce a bounding box enclosing the saliency region nearest the center of the preview. This trained technique assumes that a user is interested in the most centralized object in the image. Alternatively, the visual saliency model can be trained to produce a bounding box enclosing all the objects of interest in the preview, or the object of interest with the highest saliency score.

Some embodiments include determining that the adjusted preview is at a magnification ratio that is below a threshold magnification ratio. For example, the magnification ratio may be below 15×. Such embodiments include transitioning from the zoomed mode of operation to the normal mode of operation. Accordingly, the zoom stabilization mode may be deactivated, and normal mode of operation may be activated. In some embodiments, in the normal mode of operation, object tracking may no longer be performed. In some embodiments, object tracking may continue to be performed, however a frame-in-frame view, and/or an enlarged view of a portion of the entire field of view (e.g., a cropped portion of the entire FOV corresponding to a framing of the ROI) may no longer be generated and/or displayed.

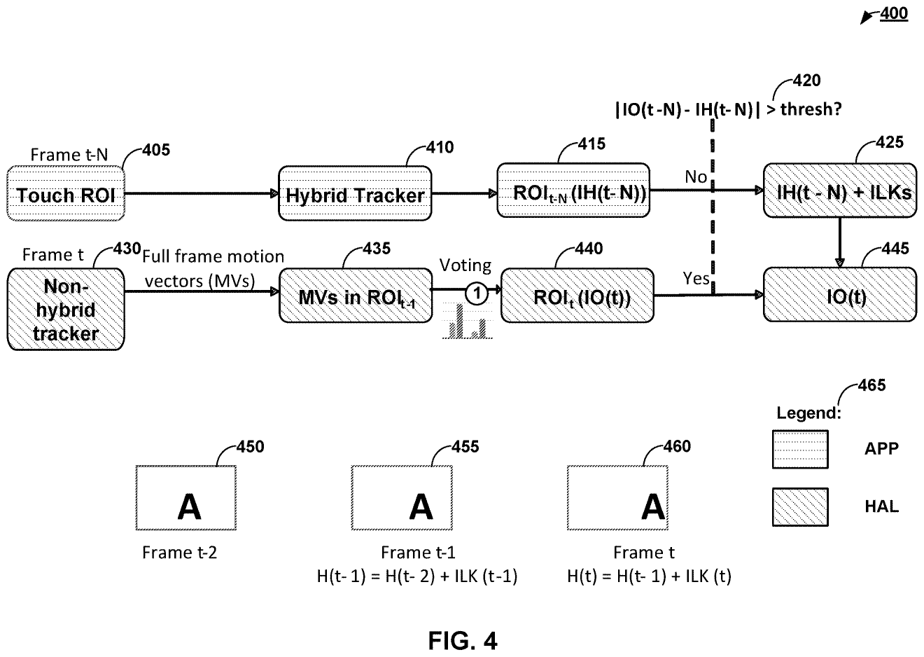

FIG. 4 is an example workflow for processing successive frames in a hybrid tracker, in accordance with example embodiments. A user tap based ROI, touch ROI 405, may be detected at frame t−N. Hybrid tracker 410 may track the ROI to determine an ROI at frame t−N as ROI_{t-N}(IH(t−N)) indicated at block 415.

The hybrid tracker path may be determined as:

$$IH ( t ) = f ( f ( f ( f ( H , t - N ) , t - N 1 ) , ... t - 1 ) \qquad ( Eqn . 2 )$$

where ƒ(H, t)=H(t)+ILK(t+1), ƒ(ƒ(x) denotes composition of the function ƒ with itself, and IH(t) represents the coordinates of the ROI based on the hybrid tracker with ILK motion vectors to predict a position of the ROI at frame t.

The non-hybrid (e.g., an optical flow based ILK) tracker 430 may determine full frame motion vectors (MV) for a frame t, and motion vectors for the ROI in frame t−1 as ROIₜ₋₁ at block 435. In some embodiments, a voting may be applied at step 1, to determine ROIₜ(IO(t)) at block 440. A non-hybrid tracker path may be determined as:

$$IO ( t ) = O ( t - 1 ) + ILK ( t ) \qquad ( Eqn . 3 )$$

where IO(t) represents the coordinates of the ROI based on the non-hybrid, or ILK, tracker. To determine a final ROI, a threshold condition 420 may be checked:

$$O ( t ) = \vert IO ( t - N ) - IH ( t - N ) \vert > thresh ? \qquad ( Eqn . 4 )$$

where O(t) represents the finalized ROI coordinates. In some embodiments, a selection between IH(t) and IO(t)) may be made. For example, upon a determination that the threshold condition 420 is not satisfied, the system may select IH(t) provided by Eqn. 2 as the selected ROI. As indicated in block 425, this ROI may be based on a combination of IH(t−N)) and the ILKs from the non-hybrid tracker. For example, when results of the two tracker methods, hybrid tracker composited with ILK motion vectors and the non-hybrid (or ILK tracker) differ a lot, this indicates occlusion and/or a non-rigid transform. Accordingly, IH(t) is selected as the hybrid tracker is more robust in handling occlusion/non-rigid transform. In such situations, the selection O(t)=IH(t) is used.

Also, for example, upon a determination that the threshold condition 420 is satisfied, the system may select the ROI as IO(t), as determined by Eqn. 3. For example, when results of the two tracker methods, hybrid tracker composited with ILK motion vectors and the non-hybrid (or ILK tracker), are close to each other, the ILK tracker provides greater accuracy, and the selection O(t)=IO(t) is used.

The selected ROI may be set as the new ROI for the iterative process.

Blocks 450-460 illustrate the process with an object of interest represented by the letter “A.” At block 450, the letter “A” is shown in frame t−2. At block 455, the letter “A” is shown at a new position at the next frame t−1. Accordingly, the hybrid tracker computes:

$$H ( t - 1 ) = H ( t - 2 ) + ILK ( t - 1 ) \qquad ( Eqn . 5 )$$

At block 460, the letter “A” is shown to have moved further to the right in the next frame t. Accordingly, the hybrid tracker computes:

$$H ( t ) = H ( t - 1 ) + ILK ( t ) \qquad ( Eqn . 6 )$$

Although the example illustrates the computation with three successive frames, a similar iterative approach applies to N successive frames. In some embodiments, the hybrid tracker may downsize the frame to 320×240, and an ROI center cropped frame may be initialized as the hybrid tracker input to make object of interest trackable after downsizing.

As described herein, the inner frame (e.g., inner frame 145) may be cropped from the entire FOV to determine an enlarged stabilized view. The crop ratio for such a crop may be set to a target digital magnification ratio or a smarter desired ratio to ensure that the ROI is within the cropped frame.

Referring back to FIG. 3B, based on the real camera pose 344, an actual ROI position may be determined, and an optimization can be performed based on the combined image information, as follows:

$$arg {min}_{{w}_{i} , {o}_{j}} {w}_{0} {E}_{RotationalSmoothness} + {w}_{1} {E}_{TranslationalSmoothness} + {w}_{2} {E}_{Protrusion} + {w}_{3} {E}_{TrackROI} \qquad ( Eqn . 7 )$$

where xₚ is a track point in the real domain and tᵥ is the target point in the virtual domain. The term argmin_{w}_{ᵢ}_{,o}_{ⱼ} w₀E_{RotationalSmoothness} reduces pitch/yaw weights to make stabilization less sensitive to gyro noise. Also, for example, the term w₁E_{TranslationalSmoothness} reduces weights to make stabilization less sensitive to OIS noise. The term w₂E_{Protrusion} corresponds to pause-movement-pause type of motions, resulting in large residual motions with traditional EIS. The virtual pose may be determined by the term E_{TrackROI}, as below:

$${E}_{TrackROI} = \vert {K}_{v} {R}_{v} {R}_{p}^{- 1} {K}_{p}^{- 1} {x}_{p} - {t}_{v} \vert \qquad ( Eqn . 8 )$$

where A⁻¹ denotes an inverse of a matrix A. Here, Kᵥ denotes an intrinsic matrix of the camera corresponding to a virtual camera pose, Rᵥ is a predicted rotation for the virtual camera pose, Kₚ denotes an intrinsic matrix of the camera corresponding to a real camera pose, Rₚ is a predicted rotation for the real camera pose. The weight term may be smaller than a traditional EIS in pitch/yaw axis, but the same weight may be maintained for the roll. Accordingly, the track term can then dominate the pitch/yaw compensation to reduce residual motions caused by gyro/OIS noise.

In some embodiments, a two-step optimization may be performed.
Step 1: Find target point tᵥ where ROI will be located in a stabilized frame.
Step 2: Find a virtual camera pose.

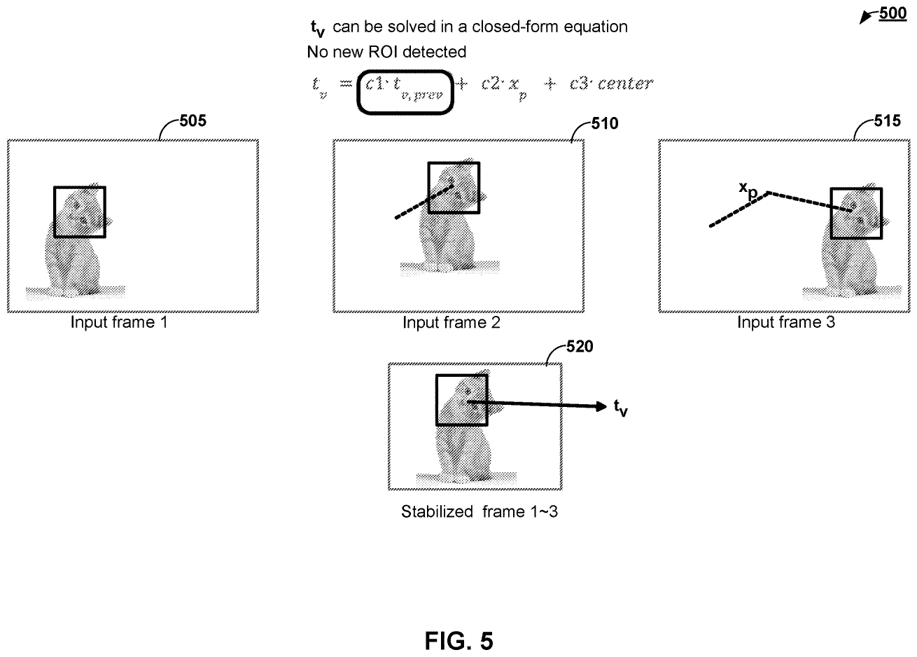

FIG. 5 depicts an example tracking optimization process, in accordance with example embodiments. Three successive input frames are shown with an image of a cat. Input frame 1 505 shows the cat to a left of the display with a bounding box on the face of the cat. Input frame 2 510 shows the cat at the center of the display with a bounding box on the face of the cat. An initial motion vector is generated based on a position of the successive bounding boxes in input frame 1 505 and input frame 2 510, as indicated by the dashed line.

Input frame 3 515 shows the cat at the right of the display with a bounding box on the face of the cat. A motion vector is generated based on the motion vector in input frame 2 510, and a position of the successive bounding boxes in input frame 2 510 and input frame 3 515, as indicated by the two dashed lines. The point xₚ is a track point in the real domain. A stabilized frame 520 can be generated based on input frames 1-3, and tᵥ is displayed as the target point in the virtual domain. The point tᵥ may be solved from a closed-form equation as follows:

$${t}_{v} = c 1 \cdot {t}_{v , prev} + c 2 \cdot {x}_{p} + c 3 \cdot center \qquad ( Eqn . 9 )$$

where the operation “.” represents multiplication, c1, c2, and c3 are positive weight coefficients that satisfy c1+c2+c3=1.

FIG. 5 illustrates how the first term c1. t_{v,prev} in Eqn. 9 is determined, where t_{v,prev} represents the coordinates of the virtual target center in a previous frame. The term c1.t_{v,prev} constrains the coordinates of tᵥ to be close to the coordinates of t_{v,prev}, and this, in turn, ensures that the center of the virtual ROI is stabilized.

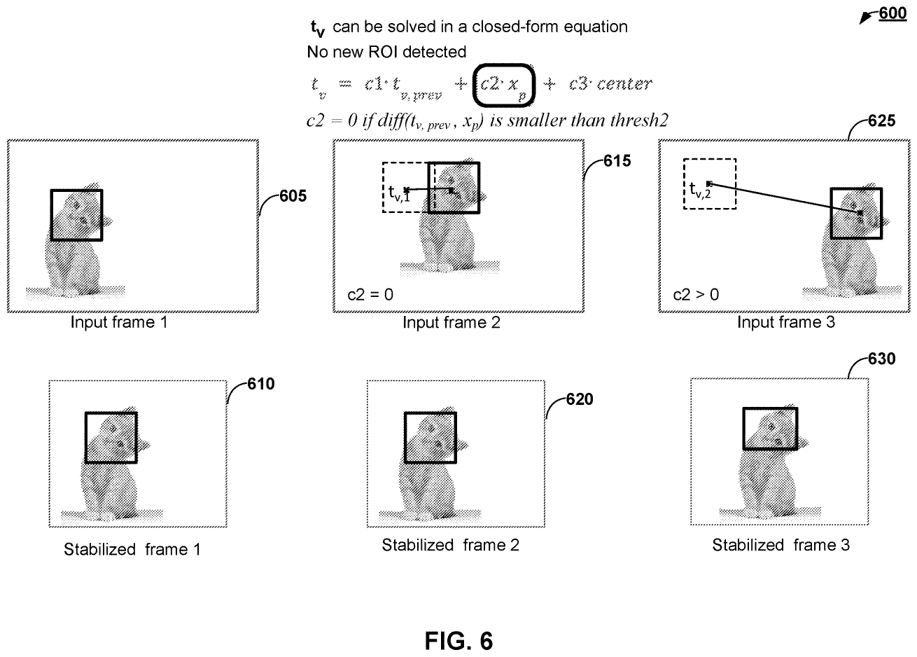

FIG. 6 depicts another example tracking optimization process, in accordance with example embodiments. Input frames 605, 615, and 625 are shown with an image of a cat moving from the left, to the center, to the right, respectively. The point tᵥ is determined at successive frames to generate stabilized frames 610, 620, and 630, corresponding respectively to input frames 605, 615, and 625. FIG. 6 illustrates an effect of the middle term c2.xₚ in Eqn. 9. Here, xₚ represents the position of the ROI in a real pose (e.g., an unstabilized frame), and so the term c2.xₚ can be adjusted to control how closely the virtual target follows the real position. For example, input frame 615 corresponds to c2=0, and the target point t_{v,1} may be determined. For example, c2=0 if diff(t_{v,prev}, xₚ) is smaller than a second threshold, thresh2, where “diff” represents a difference, or a distance. Input frame 625 corresponds to the case c2>0, and the target point t_{v,2} may be determined. As indicated by stabilized frames 610, 620, and 630, even though the position of the cat shifts in input frames 605, 615, and 620, the position of the cat in the indicated by stabilized frames 610, 620, and 630 is maintained at or near the center of the frame. The point tᵥ may be solved from the closed-form equation, Eqn. 9.

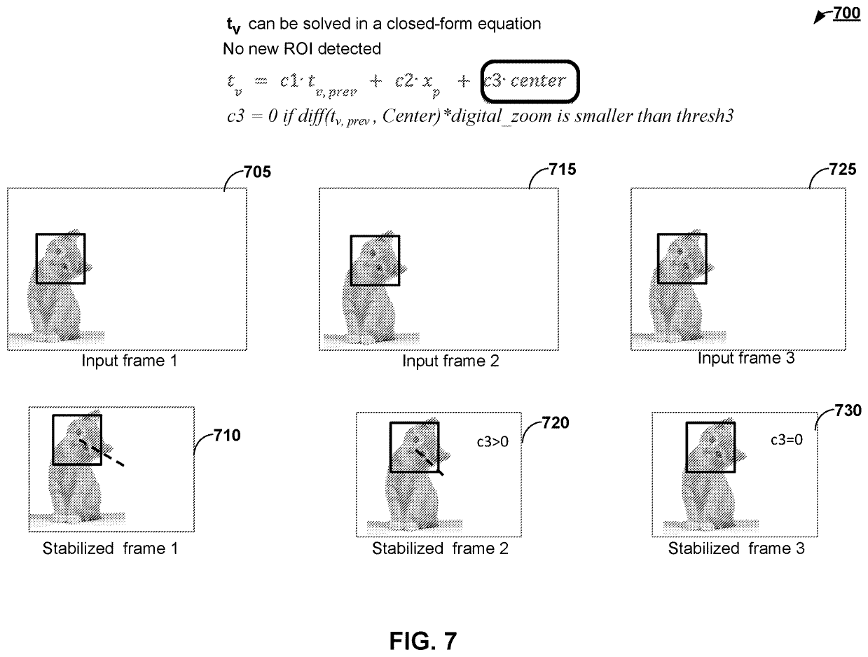

FIG. 7 depicts another example tracking optimization process, in accordance with example embodiments. Input frames 705, 715, and 725 are shown with an image of a cat to the left, and stabilized frames 710, 720, and 730, corresponding respectively to input frames 705, 715, and 725. Again, the point tᵥ may be solved from the closed-form equation, Eqn. 9. This example illustrates the third term c3.center in Eqn. 9. In this example, c3=0 if diff(t_{v,prev}, Center)*digital_zoom_factor is smaller than a third threshold, thresh3. The term diff(ty, Center) represents a distance between tᵥ and an absolute center of the stabilized frame. Accordingly, the condition that this distance is smaller than a threshold ensures that the virtual ROI is not at or near the border of the stabilized frame. Stabilized frame 2 720 illustrates the case c3>0, while stabilized frame 3 730 illustrates the case c3=0.

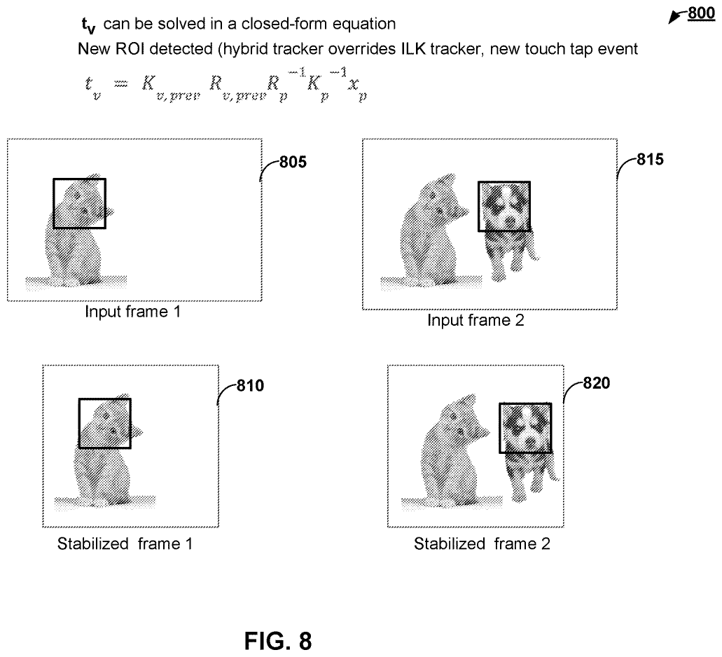

FIG. 8 depicts an example tracking optimization process for two regions of interest, in accordance with example embodiments. For example, input frame 1 805 has the image of a cat, and a new object of interest represented by a dog is detected in input frame 2 815. The new ROI may be detected by a touch tap event (e.g., a user taps the display to indicate the ROI). In the event of the new ROI, the hybrid tracker described herein overrides the non-hybrid (also referred to herein as ILK) tracker. The point tᵥ may be solved from the closed-form equation:

$${t}_{v} = {K}_{v} {R}_{v} {R}_{p}^{- 1} {K}_{p}^{- 1} {x}_{p} \qquad ( Eqn . 10 )$$

where, xₚ represents the position of the ROI in a real pose, tᵥ represents the position of the ROI in a virtual pose, A⁻¹ denotes an inverse of a matrix A. Here, Kᵥ denotes an intrinsic matrix of the camera corresponding to a virtual camera pose, Rᵥ is a predicted rotation for the virtual camera pose, Kₚ denotes an intrinsic matrix of the camera corresponding to a real camera pose, Rₚ is a predicted rotation for the real camera pose.

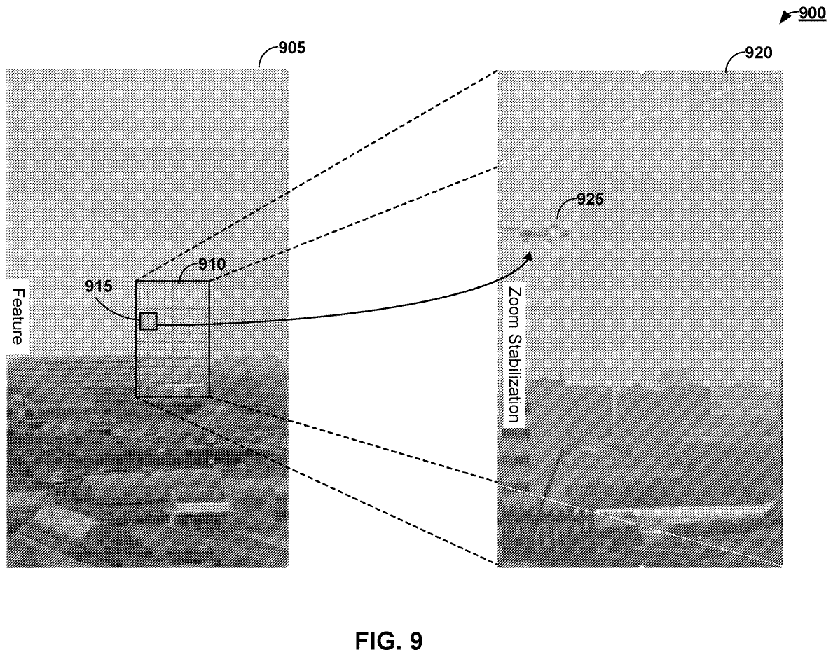

FIG. 9 illustrates an example image with stabilized object tracking, in accordance with example embodiments. An initial FOV 905 is shown with a bounding box 915 indicating an object of interest (e.g., an airplane). A warping mesh 910 is shown. For example, after determining a virtual camera pose, a stabilization mesh, such as warping mesh 910, from a physical camera to a virtual camera, may be generated by determining, for each horizontal stripe, a source quadrilateral and a destination quadrilateral. In some embodiments, warping mesh 910 may be cropped from the entire initial FOV 905 to generate an enlarged FOV 920. The object of interest, in this example, an airplane 925, is shown in a zoomed-in view in enlarged FOV 920. As illustrated, the airplane 925 is in clear view, and may be tracked smoothly based on motion vectors in successive frames.

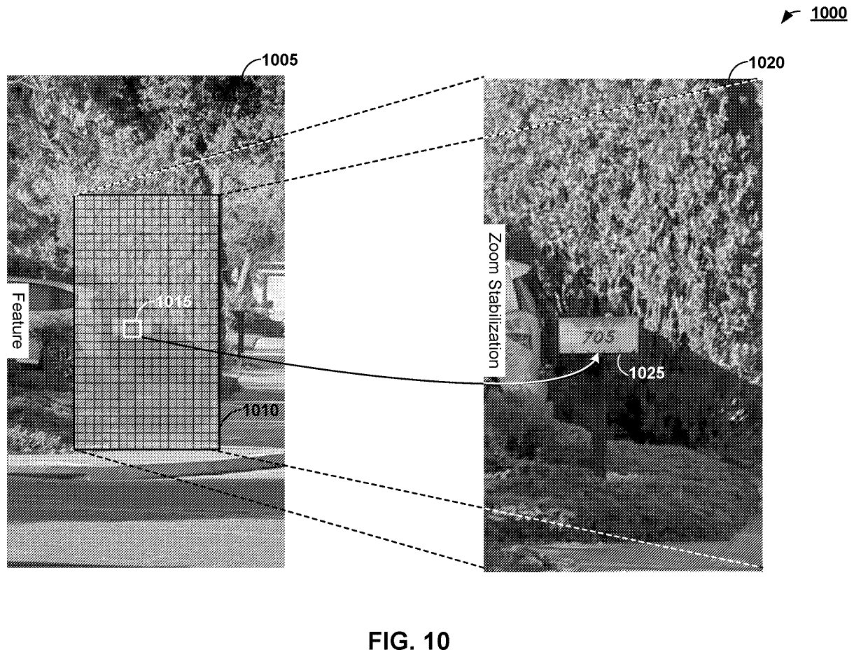

FIG. 10 illustrates another example image with stabilized object tracking, in accordance with example embodiments. An initial FOV 1005 is shown with a bounding box 1015 indicating an object of interest (e.g., a mailbox displaying a house number). A warping mesh 1010 is shown. For example, after determining a virtual camera pose, a stabilization mesh, such as warping mesh 1010, from a physical camera to a virtual camera, may be generated by determining, for each horizontal stripe, a source quadrilateral and a destination quadrilateral. In some embodiments, warping mesh 1010 may be cropped from the entire initial FOV 1005 to generate an enlarged FOV 1020. The object of interest, in this example, the mailbox 1025 displaying the house number, is shown in a zoomed-in view in enlarged FOV 1020. As illustrated, the mailbox 1025 is in clear view, and the house number “705” can be discerned.

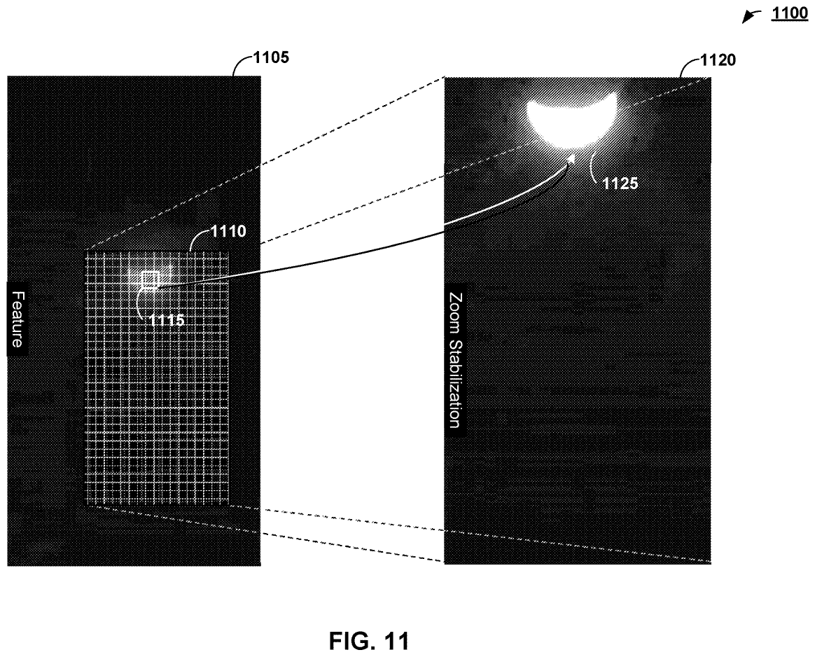

FIG. 11 illustrates another example image with stabilized object tracking, in accordance with example embodiments. An initial FOV 1105 is shown with a bounding box 1115 indicating an object of interest (e.g., the moon). A warping mesh 1110 is shown. For example, after determining a virtual camera pose, a stabilization mesh, such as warping mesh 1110, from a physical camera to a virtual camera, may be generated by determining, for each horizontal stripe, a source quadrilateral and a destination quadrilateral. In some embodiments, warping mesh 1110 may be cropped from the entire initial FOV 1105 to generate an enlarged FOV 1120. The object of interest, in this example, the moon 1125, is shown in a zoomed-in view in enlarged FOV 1120. As illustrated, the moon 1125 is in clear view, and may be tracked smoothly based on motion vectors in successive frames.

As described herein, a magnification ratio for telephoto, Tele RM, may be at 9.4×, and a magnification ratio for the zoom stabilization may be at 15×. The zoom ratios are for illustrative purposes only, and may differ with device, and/or system configurations. The image capturing device may transition between two modes, normal mode with no zoom stabilization, and a zoom stabilization mode. In some embodiments, the zoom stabilization mode may be governed by a combination of the magnification ratio and a mesh interpolation. In some embodiments, the transition may be between a baseline EIS mode and a Center ROI based zoom stabilization mode. Generally, transitions are seamless, with and/or without the ROI tracking term. For example, the transition between Center ROI and ROI source may be seamless, by adjusting the virtual ROI target and re-tracking transition between different ROI sources. Also, for example, a transition between a binning mode and remosaic mode may be seamless, by performing a frame-in-frame cropping of the YUV in the camera application, and adjusting the EIS margin accordingly.

### Training Machine Learning Models for Generating Inferences/Predictions

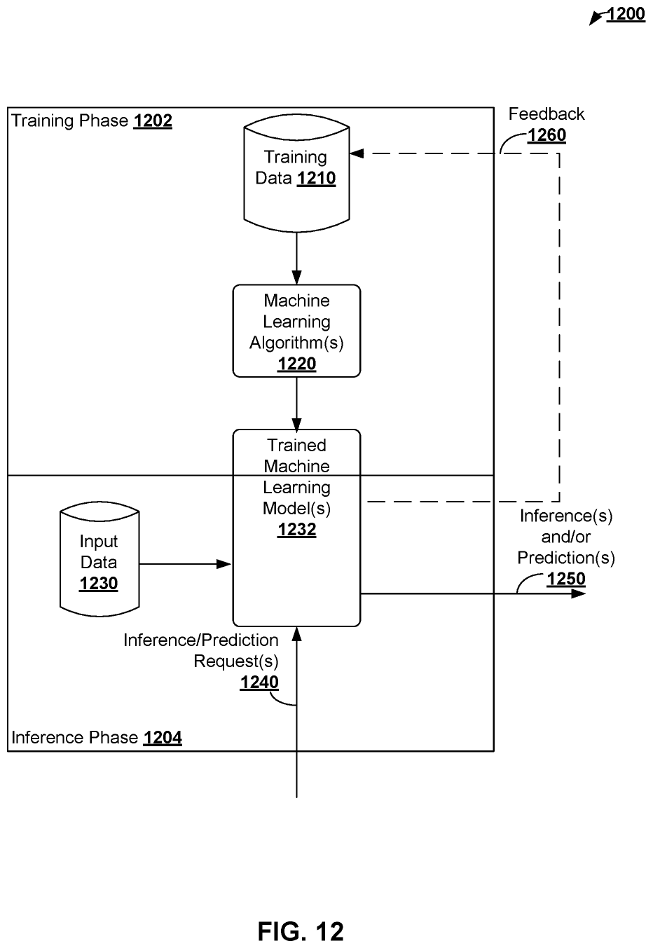

FIG. 12 shows diagram 1200 illustrating a training phase 1202 and an inference phase 1204 of trained machine learning model(s) 1232, in accordance with example embodiments. Some machine learning techniques involve training one or more machine learning algorithms on an input set of training data to recognize patterns in the training data and provide output inferences and/or predictions about (patterns in the) training data. The resulting trained machine learning algorithm can be termed as a trained machine learning model. For example, FIG. 12 shows training phase 1202 where one or more machine learning algorithms 1220 are being trained on training data 1210 to become trained machine learning model 1232. Then, during inference phase 1204, trained machine learning model 1232 can receive input data 1230 and one or more inference/prediction requests 1240 (perhaps as part of input data 1230) and responsively provide as an output one or more inferences and/or predictions 1250.

As such, trained machine learning model(s) 1232 can include one or more models of one or more machine learning algorithms 1220. Machine learning algorithm(s) 1220 may include, but are not limited to: an artificial neural network (e.g., a herein-described convolutional neural networks, a recurrent neural network, a Bayesian network, a hidden Markov model, a Markov decision process, a logistic regression function, a support vector machine, a suitable statistical machine learning algorithm, and/or a heuristic machine learning system). Machine learning algorithm(s) 1220 may be supervised or unsupervised, and may implement any suitable combination of online and offline learning.

In some examples, machine learning algorithm(s) 1220 and/or trained machine learning model(s) 1232 can be accelerated using on-device coprocessors, such as graphic processing units (GPUs), tensor processing units (TPUs), digital signal processors (DSPs), and/or application specific integrated circuits (ASICs). Such on-device coprocessors can be used to speed up machine learning algorithm(s) 1220 and/or trained machine learning model(s) 1232. In some examples, trained machine learning model(s) 1232 can be trained, reside and execute to provide inferences on a particular computing device, and/or otherwise can make inferences for the particular computing device.

During training phase 1202, machine learning algorithm(s) 1220 can be trained by providing at least training data 1210 as training input using unsupervised, supervised, semi-supervised, and/or reinforcement learning techniques. Unsupervised learning involves providing a portion (or all) of training data 1210 to machine learning algorithm(s) 1220 and machine learning algorithm(s) 1220 determining one or more output inferences based on the provided portion (or all) of training data 1210. Supervised learning involves providing a portion of training data 1210 to machine learning algorithm(s) 1220, with machine learning algorithm(s) 1220 determining one or more output inferences based on the provided portion of training data 1210, and the output inference(s) are either accepted or corrected based on correct results associated with training data 1210. In some examples, supervised learning of machine learning algorithm(s) 1220 can be governed by a set of rules and/or a set of labels for the training input, and the set of rules and/or set of labels may be used to correct inferences of machine learning algorithm(s) 1220.

Semi-supervised learning involves having correct results for part, but not all, of training data 1210. During semi-supervised learning, supervised learning is used for a portion of training data 1210 having correct results, and unsupervised learning is used for a portion of training data 1210 not having correct results. Reinforcement learning involves machine learning algorithm(s) 1220 receiving a reward signal regarding a prior inference, where the reward signal can be a numerical value. During reinforcement learning, machine learning algorithm(s) 1220 can output an inference and receive a reward signal in response, where machine learning algorithm(s) 1220 are configured to try to maximize the numerical value of the reward signal. In some examples, reinforcement learning also utilizes a value function that provides a numerical value representing an expected total of the numerical values provided by the reward signal over time. In some examples, machine learning algorithm(s) 1220 and/or trained machine learning model(s) 1232 can be trained using other machine learning techniques, including but not limited to, incremental learning and curriculum learning.

In some examples, machine learning algorithm(s) 1220 and/or trained machine learning model(s) 1232 can use transfer learning techniques. For example, transfer learning techniques can involve trained machine learning model(s) 1232 being pre-trained on one set of data and additionally trained using training data 1210. More particularly, machine learning algorithm(s) 1220 can be pre-trained on data from one or more computing devices and a resulting trained machine learning model provided to computing device CD1, where CD1 is intended to execute the trained machine learning model during inference phase 1204. Then, during training phase 1202, the pre-trained machine learning model can be additionally trained using training data 1210, where training data 1210 can be derived from kernel and non-kernel data of computing device CD1. This further training of the machine learning algorithm(s) 1220 and/or the pre-trained machine learning model using training data 1210 of CD1's data can be performed using either supervised or unsupervised learning. Once machine learning algorithm(s) 1220 and/or the pre-trained machine learning model has been trained on at least training data 1210, training phase 1202 can be completed. The trained resulting machine learning model can be utilized as at least one of trained machine learning model(s) 1232.

In particular, once training phase 1202 has been completed, trained machine learning model(s) 1232 can be provided to a computing device, if not already on the computing device. Inference phase 1204 can begin after trained machine learning model(s) 1232 are provided to computing device CD1.

During inference phase 1204, trained machine learning model(s) 1232 can receive input data 1230 and generate and output one or more corresponding inferences and/or predictions 1250 about input data 1230. As such, input data 1230 can be used as an input to trained machine learning model(s) 1232 for providing corresponding inference(s) and/or prediction(s) 1250 to kernel components and non-kernel components. For example, trained machine learning model(s) 1232 can generate inference(s) and/or prediction(s) 1250 in response to one or more inference/prediction requests 1240. In some examples, trained machine learning model(s) 1232 can be executed by a portion of other software. For example, trained machine learning model(s) 1232 can be executed by an inference or prediction daemon to be readily available to provide inferences and/or predictions upon request. Input data 1230 can include data from computing device CD1 executing trained machine learning model(s) 1232 and/or input data from one or more computing devices other than CD1.

Training data 1210 can include images (e.g., digital photographs), including user-drawn bounding boxes containing a visual saliency region (e.g., a region wherein one or more objects of particular interest to a user may reside).

Input data 1230 can include one or more captured images, or a preview of an image. Other types of input data are possible as well.

Inference(s) and/or prediction(s) 1250 can include output images, a bounding box enclosing a region of interest with a greatest probability of visual saliency, and/or other output data produced by trained machine learning model(s) 1232 operating on input data 1230 (and training data 1210). In some examples, trained machine learning model(s) 1232 can use output inference(s) and/or prediction(s) 1250 as input feedback 1260. Trained machine learning model(s) 1232 can also rely on past inferences as inputs for generating new inferences.

Convolutional neural networks, such as a Visual Saliency Model, and so forth can be examples of machine learning algorithm(s) 1220. After training, the trained version of convolutional neural networks can be examples of trained machine learning model(s) 1232. In this approach, an example of inference/prediction request(s) 1240 can be a request to predict a region of interest in a preview of an image, and a corresponding example of inferences and/or prediction(s) 1250 can be an output image with bounding boxes containing a visual saliency region.

In some examples, one computing device CD_SOLO can include the trained version of convolutional neural network 100, perhaps after training convolutional neural network. Then, computing device CD_SOLO can receive requests to predict a region of interest in a preview of an image, and use the trained version of convolutional neural network to generate the output image with bounding boxes containing a visual saliency region.

In some examples, two or more computing devices CD_CLI and CD_SRV can be used to provide output images; e.g., a first computing device CD_CLI can generate and send requests to predict a region of interest in a preview of an image to a second computing device CD_SRV. Then, CD_SRV can use the trained version of convolutional neural network, perhaps after training convolutional neural network, to generate the output image with bounding boxes containing a visual saliency region, and respond to the request from CD_CLI for the predict a region of interest in a preview of an image. Then, upon reception of responses to the requests, CD_CLI can provide the requested region of interest, using a user interface and/or a display). Example Data Network

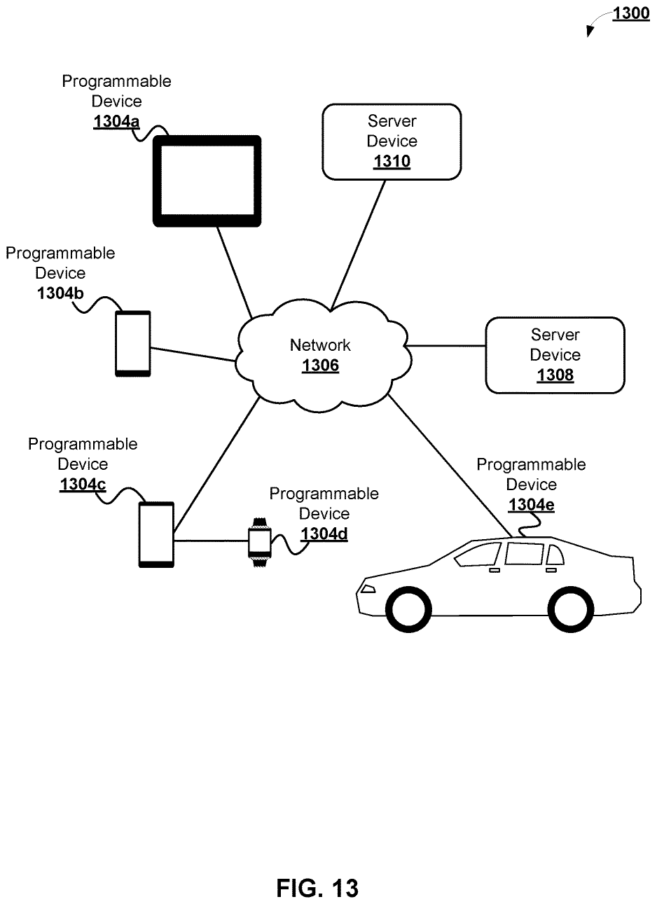

FIG. 13 depicts a distributed computing architecture 1300, in accordance with example embodiments. Distributed computing architecture 1300 includes server devices 1308, 1310 that are configured to communicate, via network 1306, with programmable devices 1304a, 1304b, 1304c, 1304d, 1304e. Network 1306 may correspond to a local area network (LAN), a wide area network (WAN), a WLAN, a WWAN, a corporate intranet, the public Internet, or any other type of network configured to provide a communications path between networked computing devices. Network 1306 may also correspond to a combination of one or more LANs, WANs, corporate intranets, and/or the public Internet.

Although FIG. 13 only shows five programmable devices, distributed application architectures may serve tens, hundreds, or thousands of programmable devices. Moreover, programmable devices 1304a, 1304b, 1304c, 1304d, 1304e (or any additional programmable devices) may be any sort of computing device, such as a mobile computing device, desktop computer, wearable computing device, head-mountable device (HMD), network terminal, a mobile computing device, and so on. In some examples, such as illustrated by programmable devices 1304a, 1304b, 1304c, 1304e, programmable devices can be directly connected to network 1306. In other examples, such as illustrated by programmable device 1304d, programmable devices can be indirectly connected to network 1306 via an associated computing device, such as programmable device 1304c. In this example, programmable device 1304c can act as an associated computing device to pass electronic communications between programmable device 1304d and network 1306. In other examples, such as illustrated by programmable device 1304e, a computing device can be part of and/or inside a vehicle, such as a car, a truck, a bus, a boat or ship, an airplane, etc. In other examples not shown in FIG. 13, a programmable device can be both directly and indirectly connected to network 1306.

Server devices 1308, 1310 can be configured to perform one or more services, as requested by programmable devices 1304a-1304e. For example, server device 1308 and/or 1310 can provide content to programmable devices 1304a-1304e. The content can include, but is not limited to, web pages, hypertext, scripts, binary data such as compiled software, images, audio, and/or video. The content can include compressed and/or uncompressed content. The content can be encrypted and/or unencrypted. Other types of content are possible as well.

As another example, server device 1308 and/or 1310 can provide programmable devices 1304a-1304e with access to software for database, search, computation, graphical, audio, video, World Wide Web/Internet utilization, and/or other functions. Many other examples of server devices are possible as well.

### Computing Device Architecture

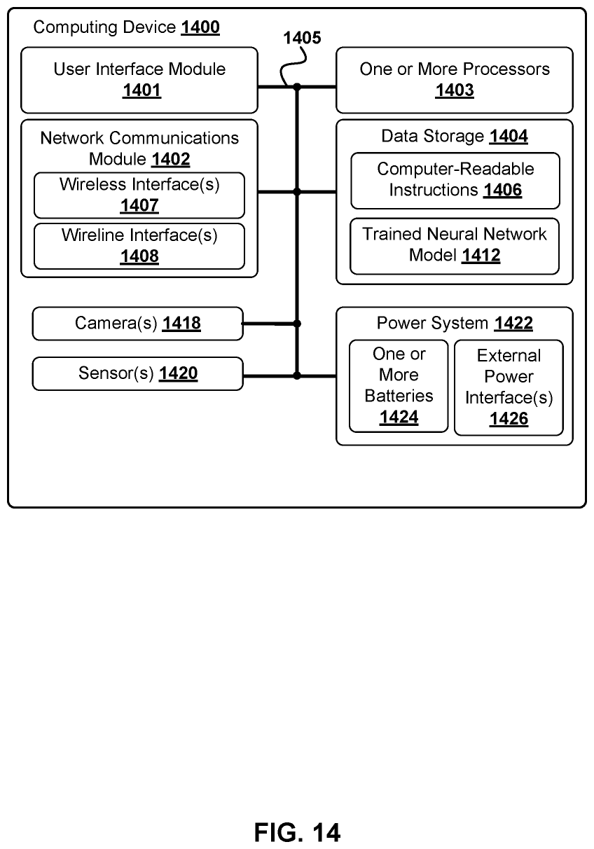

FIG. 14 is a block diagram of an example computing device 1400, in accordance with example embodiments. In particular, computing device 1400 shown in FIG. 14 can be configured to perform at least one function of and/or related to method 1600.

Computing device 1400 may include a user interface module 1401, a network communications module 1402, one or more processors 1403, data storage 1404, one or more cameras 1418, one or more sensors 1420, and power system 1422, all of which may be linked together via a system bus, network, or other connection mechanism 1405.

User interface module 1401 can be operable to send data to and/or receive data from external user input/output devices. For example, user interface module 1401 can be configured to send and/or receive data to and/or from user input devices such as a touch screen, a computer mouse, a keyboard, a keypad, a touch pad, a trackball, a joystick, a voice recognition module, and/or other similar devices. User interface module 1401 can also be configured to provide output to user display devices, such as one or more cathode ray tubes (CRT), liquid crystal displays, light emitting diodes (LEDs), displays using digital light processing (DLP) technology, printers, light bulbs, and/or other similar devices, either now known or later developed. User interface module 1401 can also be configured to generate audible outputs, with devices such as a speaker, speaker jack, audio output port, audio output device, earphones, and/or other similar devices. User interface module 1401 can further be configured with one or more haptic devices that can generate haptic outputs, such as vibrations and/or other outputs detectable by touch and/or physical contact with computing device 1400. In some examples, user interface module 1401 can be used to provide a graphical user interface (GUI) for utilizing computing device 1400.

Network communications module 1402 can include one or more devices that provide one or more wireless interfaces 1407 and/or one or more wireline interfaces 1408 that are configurable to communicate via a network. Wireless interface(s) 1407 can include one or more wireless transmitters, receivers, and/or transceivers, such as a Bluetooth™ transceiver, a Zigbee® transceiver, a Wi-Fi™ transceiver, a WiMAX™ transceiver, an LTE™ transceiver, and/or other type of wireless transceiver configurable to communicate via a wireless network. Wireline interface(s) 1408 can include one or more wireline transmitters, receivers, and/or transceivers, such as an Ethernet transceiver, a Universal Serial Bus (USB) transceiver, or similar transceiver configurable to communicate via a twisted pair wire, a coaxial cable, a fiber-optic link, or a similar physical connection to a wireline network.

In some examples, network communications module 1402 can be configured to provide reliable, secured, and/or authenticated communications. For each communication described herein, information for facilitating reliable communications (e.g., guaranteed message delivery) can be provided, perhaps as part of a message header and/or footer (e.g., packet/message sequencing information, encapsulation headers and/or footers, size/time information, and transmission verification information such as cyclic redundancy check (CRC) and/or parity check values). Communications can be made secure (e.g., be encoded or encrypted) and/or decrypted/decoded using one or more cryptographic protocols and/or algorithms, such as, but not limited to, Data Encryption Standard (DES), Advanced Encryption Standard (AES), a Rivest-Shamir-Adelman (RSA) algorithm, a Diffie-Hellman algorithm, a secure sockets protocol such as Secure Sockets Layer (SSL) or Transport Layer Security (TLS), and/or Digital Signature Algorithm (DSA). Other cryptographic protocols and/or algorithms can be used as well or in addition to those listed herein to secure (and then decrypt/decode) communications.

One or more processors 1403 can include one or more general purpose processors, and/or one or more special purpose processors (e.g., digital signal processors, tensor processing units (TPUs), graphics processing units (GPUs), application specific integrated circuits, etc.). One or more processors 1403 can be configured to execute computer-readable instructions 1406 that are contained in data storage 1404 and/or other instructions as described herein.

Data storage 1404 can include one or more non-transitory computer-readable storage media that can be read and/or accessed by at least one of one or more processors 1403. The one or more computer-readable storage media can include volatile and/or non-volatile storage components, such as optical, magnetic, organic or other memory or disc storage, which can be integrated in whole or in part with at least one of one or more processors 1403. In some examples, data storage 1404 can be implemented using a single physical device (e.g., one optical, magnetic, organic or other memory or disc storage unit), while in other examples, data storage 1404 can be implemented using two or more physical devices.

Data storage 1404 can include computer-readable instructions 1406 and perhaps additional data. In some examples, data storage 1404 can include storage required to perform at least part of the herein-described methods, scenarios, and techniques and/or at least part of the functionality of the herein-described devices and networks. In some examples, data storage 1404 can include storage for a trained neural network model 1412 (e.g., a model of trained convolutional neural networks). In particular of these examples, computer-readable instructions 1406 can include instructions that, when executed by processor(s) 1403, enable computing device 1400 to provide for some or all of the functionality of trained neural network model 1412.

In some examples, computing device 1400 can include one or more cameras 1418. Camera(s) 1418 can include one or more image capture devices, such as still and/or video cameras, equipped to capture light and record the captured light in one or more images; that is, camera(s) 1418 can generate image(s) of captured light. The one or more images can be one or more still images and/or one or more images utilized in video imagery. Camera(s) 1418 can capture light and/or electromagnetic radiation emitted as visible light, infrared radiation, ultraviolet light, and/or as one or more other frequencies of light.

In some examples, computing device 1400 can include one or more sensors 1420. Sensors 1420 can be configured to measure conditions within computing device 1400 and/or conditions in an environment of computing device 1400 and provide data about these conditions. For example, sensors 1420 can include one or more of: (i) sensors for obtaining data about computing device 1400, such as, but not limited to, a thermometer for measuring a temperature of computing device 1400, a battery sensor for measuring power of one or more batteries of power system 1422, and/or other sensors measuring conditions of computing device 1400; (ii) an identification sensor to identify other objects and/or devices, such as, but not limited to, a Radio Frequency Identification (RFID) reader, proximity sensor, one-dimensional barcode reader, two-dimensional barcode (e.g., Quick Response (QR) code) reader, and a laser tracker, where the identification sensors can be configured to read identifiers, such as RFID tags, barcodes, QR codes, and/or other devices and/or object configured to be read and provide at least identifying information; (iii) sensors to measure locations and/or movements of computing device 1400, such as, but not limited to, a tilt sensor, a gyroscope, an accelerometer, a Doppler sensor, a GPS device, a sonar sensor, a radar device, a laser-displacement sensor, and a compass; (iv) an environmental sensor to obtain data indicative of an environment of computing device 1400, such as, but not limited to, an infrared sensor, an optical sensor, a light sensor, a biosensor, a capacitive sensor, a touch sensor, a temperature sensor, a wireless sensor, a radio sensor, a movement sensor, a microphone, a sound sensor, an ultrasound sensor and/or a smoke sensor; and/or (v) a force sensor to measure one or more forces (e.g., inertial forces and/or G-forces) acting about computing device 1400, such as, but not limited to one or more sensors that measure: forces in one or more dimensions, torque, ground force, friction, and/or a zero moment point (ZMP) sensor that identifies ZMPs and/or locations of the ZMPs. Many other examples of sensors 1420 are possible as well.

Power system 1422 can include one or more batteries 1424 and/or one or more external power interfaces 1426 for providing electrical power to computing device 1400. Each battery of the one or more batteries 1424 can, when electrically coupled to the computing device 1400, act as a source of stored electrical power for computing device 1400. One or more batteries 1424 of power system 1422 can be configured to be portable. Some or all of one or more batteries 1424 can be readily removable from computing device 1400. In other examples, some or all of one or more batteries 1424 can be internal to computing device 1400, and so may not be readily removable from computing device 1400. Some or all of one or more batteries 1424 can be rechargeable. For example, a rechargeable battery can be recharged via a wired connection between the battery and another power supply, such as by one or more power supplies that are external to computing device 1400 and connected to computing device 1400 via the one or more external power interfaces. In other examples, some or all of one or more batteries 1424 can be non-rechargeable batteries.

One or more external power interfaces 1426 of power system 1422 can include one or more wired-power interfaces, such as a USB cable and/or a power cord, that enable wired electrical power connections to one or more power supplies that are external to computing device 1400. One or more external power interfaces 1426 can include one or more wireless power interfaces, such as a Qi wireless charger, that enable wireless electrical power connections, such as via a Qi wireless charger, to one or more external power supplies. Once an electrical power connection is established to an external power source using one or more external power interfaces 1426, computing device 1400 can draw electrical power from the external power source the established electrical power connection. In some examples, power system 1422 can include related sensors, such as battery sensors associated with the one or more batteries or other types of electrical power sensors.

### Cloud-Based Servers

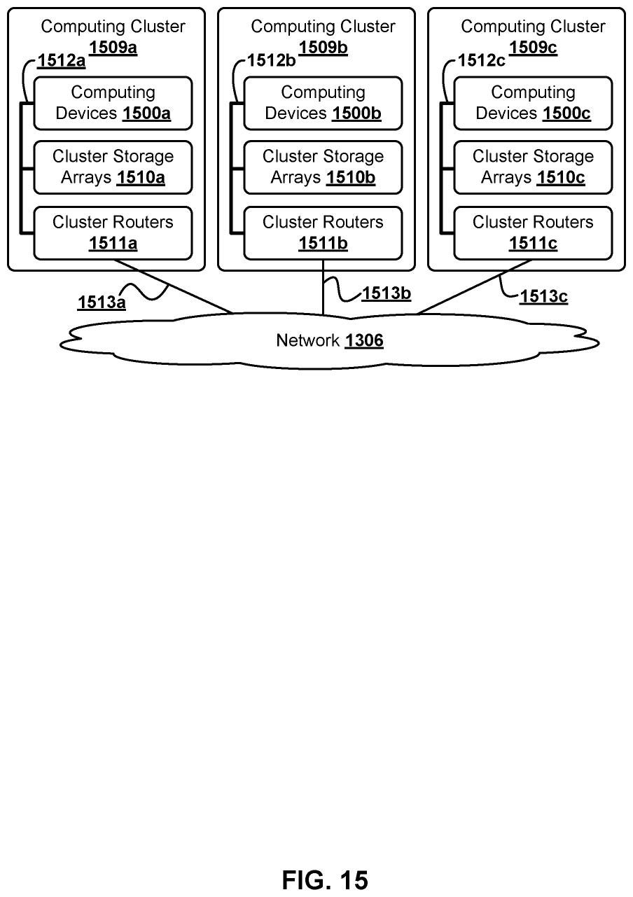

FIG. 15 depicts a cloud-based server system in accordance with an example embodiment. In FIG. 15, functionality of convolutional neural networks, and/or a computing device can be distributed among computing clusters 1509a, 1509b, 1509c. Computing cluster 1509a can include one or more computing devices 1500a, cluster storage arrays 1510a, and cluster routers 1511a connected by a local cluster network 1512a. Similarly, computing cluster 1509b can include one or more computing devices 1500b, cluster storage arrays 1510b, and cluster routers 1511b connected by a local cluster network 1512b. Likewise, computing cluster 1509c can include one or more computing devices 1500c, cluster storage arrays 1510c, and cluster routers 1511c connected by a local cluster network 1512c.

In some embodiments, each of computing clusters 1509a, 1509b, and 1509c can have an equal number of computing devices, an equal number of cluster storage arrays, and an equal number of cluster routers. In other embodiments, however, each computing cluster can have different numbers of computing devices, different numbers of cluster storage arrays, and different numbers of cluster routers. The number of computing devices, cluster storage arrays, and cluster routers in each computing cluster can depend on the computing task or tasks assigned to each computing cluster.

In computing cluster 1509a, for example, computing devices 1500a can be configured to perform various computing tasks of convolutional neural network, confidence learning, and/or a computing device. In one embodiment, the various functionalities of a convolutional neural network, confidence learning, and/or a computing device can be distributed among one or more of computing devices 1500a, 1500b, 1500c. Computing devices 1500b and 1500c in respective computing clusters 1509b and 1509c can be configured similarly to computing devices 1500a in computing cluster 1509a. On the other hand, in some embodiments, computing devices 1500a, 1500b, and 1500c can be configured to perform different functions.

In some embodiments, computing tasks and stored data associated with a convolutional neural networks, and/or a computing device can be distributed across computing devices 1500a, 1500b, and 1500c based at least in part on the processing requirements of a convolutional neural networks, and/or a computing device, the processing capabilities of computing devices 1500a, 1500b, 1500c, the latency of the network links between the computing devices in each computing cluster and between the computing clusters themselves, and/or other factors that can contribute to the cost, speed, fault-tolerance, resiliency, efficiency, and/or other design goals of the overall system architecture.

Cluster storage arrays 1510a, 1510b, 1510c of computing clusters 1509a, 1509b, 1509c can be data storage arrays that include disk array controllers configured to manage read and write access to groups of hard disk drives. The disk array controllers, alone or in conjunction with their respective computing devices, can also be configured to manage backup or redundant copies of the data stored in the cluster storage arrays to protect against disk drive or other cluster storage array failures and/or network failures that prevent one or more computing devices from accessing one or more cluster storage arrays.

Similar to the manner in which the functions of convolutional neural networks, and/or a computing device can be distributed across computing devices 1500a, 1500b, 1500c of computing clusters 1509a, 1509b, 1509c, various active portions and/or backup portions of these components can be distributed across cluster storage arrays 1510a, 1510b, 1510c. For example, some cluster storage arrays can be configured to store one portion of the data of a convolutional neural network, and/or a computing device, while other cluster storage arrays can store other portion(s) of data of a convolutional neural network, and/or a computing device. Also, for example, some cluster storage arrays can be configured to store the data of a first convolutional neural network, while other cluster storage arrays can store the data of a second and/or third convolutional neural network. Additionally, some cluster storage arrays can be configured to store backup versions of data stored in other cluster storage arrays.

Cluster routers 1511a, 1511b, 1511c in computing clusters 1509a, 1509b, 1509c can include networking equipment configured to provide internal and external communications for the computing clusters. For example, cluster routers 1511a in computing cluster 1509a can include one or more internet switching and routing devices configured to provide (i) local area network communications between computing devices 1500a and cluster storage arrays 1510a via local cluster network 1512a, and (ii) wide area network communications between computing cluster 1509a and computing clusters 1509b and 1509c via wide area network link 1513a to network 1306. Cluster routers 1511b and 1511c can include network equipment similar to cluster routers 1511a, and cluster routers 1511b and 1511c can perform similar networking functions for computing clusters 1509b and 1509b that cluster routers 1511a perform for computing cluster 1509a.

In some embodiments, the configuration of cluster routers 1511a, 1511b, 1511c can be based at least in part on the data communication requirements of the computing devices and cluster storage arrays, the data communications capabilities of the network equipment in cluster routers 1511a, 1511b, 1511c, the latency and throughput of local cluster networks 1512a, 1512b, 1512c, the latency, throughput, and cost of wide area network links 1513a, 1513b, 1513c, and/or other factors that can contribute to the cost, speed, fault-tolerance, resiliency, efficiency and/or other design criteria of the moderation system architecture.

### Example Methods of Operation

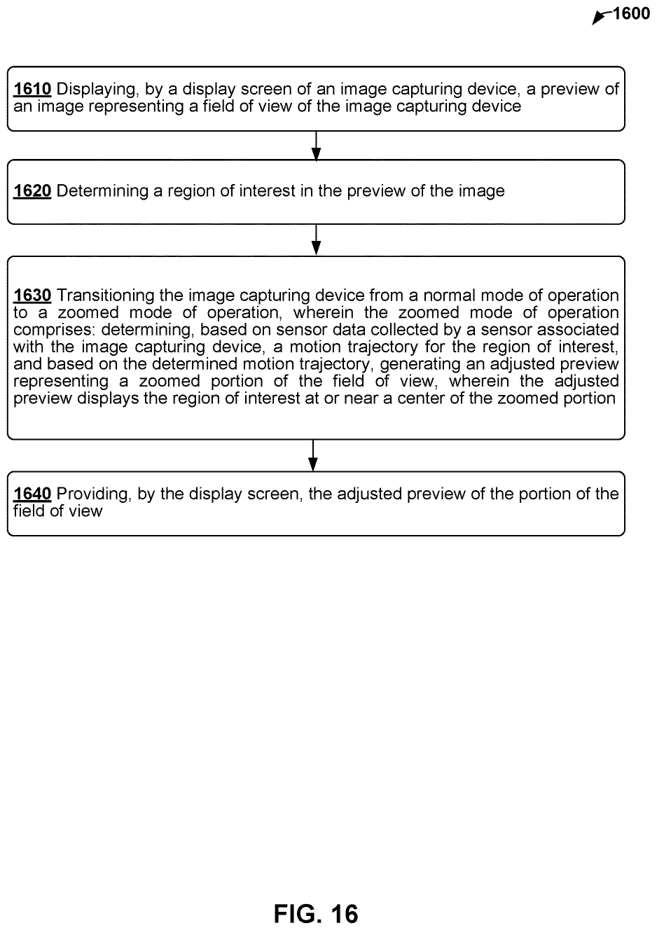

FIG. 16 illustrates a method 1600, in accordance with example embodiments. Method 1600 may include various blocks or steps. The blocks or steps may be carried out individually or in combination. The blocks or steps may be carried out in any order and/or in series or in parallel. Further, blocks or steps may be omitted or added to method 1600.

The blocks of method 1600 may be carried out by various elements of computing device 1400 as illustrated and described in reference to FIG. 8.

Block 1610 includes displaying, by a display screen of an image capturing device, a preview of an image representing a field of view of the image capturing device.

Block 1620 includes determining a region of interest in the preview of the image.

Block 1630 includes transitioning the image capturing device from a normal mode of operation to a zoomed mode of operation, wherein the zoomed mode of operation comprises: determining, based on sensor data collected by a sensor associated with the image capturing device, a motion trajectory for the region of interest, and based on the determined motion trajectory, generating an adjusted preview representing a zoomed portion of the field of view, wherein the adjusted preview displays the region of interest at or near a center of the zoomed portion.

Block 1640 includes providing, by the display screen, the adjusted preview of the portion of the field of view.

Some embodiments include providing, by the display screen, an image overlay that displays a representation of the zoomed portion relative to the field of view.

Some embodiments include determining a bounding box for the region of interest, and wherein the providing of the image overlay comprises providing the region of interest framed within the bounding box.

Some embodiments include determining one or more of (i) a lower resolution version of the displayed image, (ii) coordinates of the adjusted region of interest within the adjusted preview, or (iii) a crop ratio. Such embodiments also include generating the image overlay to enable a dynamic visualization of the bounding box.

Some embodiments include detecting that the region of interest is approaching a boundary of the image overlay. Such embodiments also include providing a notification to the user indicating that the region of interest is approaching the boundary of the image overlay.

Some embodiments include determining a motion vector associated with a previous image frame and a current image frame. Such embodiments also include determining a size of the region of interest based on the determined motion vector.

Some embodiments include determining an optical flow corresponding to the region of interest. Such embodiments also include tracking the region of interest within the portion of the field of view based on the determined optical flow, and wherein the adjusting of the preview of the image is based on the tracking of the region of interest.

Some embodiments include tracking the region of interest within the field of view based on a combination of a motion vector process and an optical flow. For example, upon determining that a transform associated with the region of interest is rigid and without occlusion, the combination of the motion vector process and the optical flow may be used to track the region of interest.

Some embodiments include tracking the region of interest within the field of view based on a hybrid tracker. For example, upon determining that a transform associated with the region of interest is non-rigid or with occlusion, the hybrid tracker may be used to track the region of interest. In some embodiments, the hybrid tracker is based on a center cropped frame to track the region of interest after a downsizing operation. In some embodiments, the hybrid tracker comprises: (a) one or more motion vectors associated with a current image frame, and (b) a saliency map indicative of the region of interest.

Some embodiments include generating the saliency map by a neural network.

In some embodiments, the preview comprises a plurality of objects, and the method includes using a saliency map to select an object of the plurality of objects, wherein the determining of the region of interest is based on the selected object.

In some embodiments, the sensor is one of a gyroscope or an optical image stabilization (OIS) sensor.

In some embodiments, the motion trajectory for the region of interest is indicative of a variable speed of movement between successive frames. In such embodiments the adjusting of the preview includes maintaining, between the successive frames of the preview, a smooth movement for the region of interest at or near the center of the zoomed portion.

In some embodiments, the motion trajectory for the region of interest is indicative of a near constant speed of movement between successive frames. In such embodiments the adjusting of the preview includes locking, between the successive frames of the preview, a position for the region of interest at or near the center of the zoomed portion.

In some embodiments, the determining of the region of interest includes receiving a user indication of the region of interest.

In some embodiments, the determining of the region of interest includes determining, based on a neural network, a saliency map indicative of the region of interest.

Some embodiments include determining that the adjusted preview is at a magnification ratio that is below a threshold magnification ratio. Such embodiments include transitioning from the zoomed mode of operation to the normal mode of operation.

The particular arrangements shown in the Figures should not be viewed as limiting. It should be understood that other embodiments may include more or less of each element shown in a given Figure. Further, some of the illustrated elements may be combined or omitted. Yet further, an illustrative embodiment may include elements that are not illustrated in the Figures.

A step or block that represents a processing of information can correspond to circuitry that can be configured to perform the specific logical functions of a herein-described method or technique. Alternatively or additionally, a step or block that represents a processing of information can correspond to a module, a segment, or a portion of program code (including related data). The program code can include one or more instructions executable by a processor for implementing specific logical functions or actions in the method or technique. The program code and/or related data can be stored on any type of computer readable medium such as a storage device including a disk, hard drive, or other storage medium.

The computer readable medium can also include non-transitory computer readable media such as computer-readable media that store data for short periods of time like register memory, processor cache, and random access memory (RAM). The computer readable media can also include non-transitory computer readable media that store program code and/or data for longer periods of time. Thus, the computer readable media may include secondary or persistent long term storage, like read only memory (ROM), optical or magnetic disks, compact-disc read only memory (CD-ROM), for example. The computer readable media can also be any other volatile or non-volatile storage systems. A computer readable medium can be considered a computer readable storage medium, for example, or a tangible storage device.

While various examples and embodiments have been disclosed, other examples and embodiments will be apparent to those skilled in the art. The various disclosed examples and embodiments are for purposes of illustration and are not intended to be limiting, with the true scope being indicated by the following claims.

1. A computer-implemented method, comprising:
displaying, by a display screen of an image capturing device, a preview of an image representing a field of view of the image capturing device;
determining a region of interest in the preview of the image;
transitioning the image capturing device from a normal mode of operation to a zoomed mode of operation, wherein the zoomed mode of operation comprises:
determining, based on sensor data collected by a sensor associated with the image capturing device, a motion trajectory for the region of interest, and
based on the determined motion trajectory, generating an adjusted preview representing a zoomed portion of the field of view, wherein the adjusted preview displays the region of interest at or near a center of the zoomed portion; and
providing, by the display screen, the adjusted preview of the portion of the field of view.

2. The method of claim 1, further comprising:
providing, by the display screen, an image overlay that displays a representation of the zoomed portion relative to the field of view.

3. The method of claim 2, further comprising:
determining a bounding box for the region of interest, and
wherein the providing of the image overlay comprises providing the region of interest framed within the bounding box.

4. The method of claim 3, further comprising:
determining one or more of (i) a lower resolution version of the displayed image, (ii) coordinates of the adjusted region of interest within the adjusted preview, or (iii) a crop ratio; and
generating the image overlay to enable a dynamic visualization of the bounding box.

5. The method of claim 2, further comprising:
detecting that the region of interest is approaching a boundary of the image overlay; and
providing a user notification indicating that the region of interest is approaching the boundary of the image overlay.

6. The method of claim 1, further comprising:
determining a motion vector associated with a previous image frame and a current image frame; and
determining a size of the region of interest based on the determined motion vector.

7. The method of claim 1, further comprising:
determining an optical flow corresponding to the region of interest; and
tracking the region of interest within the portion of the field of view based on the determined optical flow, and
wherein the adjusting of the preview of the image is based on the tracking of the region of interest.

8. The method of claim 1, further comprising:
tracking the region of interest within the field of view based on a combination of a motion vector process and an optical flow.

9. The method of claim 1, further comprising:
tracking the region of interest within the field of view based on a hybrid tracker.

10. The method of claim 9, wherein the hybrid tracker is based on a center cropped frame to track the region of interest after a downsizing operation.

11. The method of claim 9, wherein the hybrid tracker comprises: (a) one or more motion vectors associated with a current image frame, and (b) a saliency map indicative of the region of interest.

12. The method of claim 11, further comprising:
generating the saliency map by a neural network.

13. The method of claim 1, wherein the preview comprises a plurality of objects, and further comprising:
using a saliency map to select an object of the plurality of objects, and
wherein the determining of the region of interest is based on the selected object.

14. The method of claim 1, wherein the sensor is one of a gyroscope or an optical image stabilization (OIS) sensor.

15. The method of claim 1, wherein the motion trajectory for the region of interest is indicative of a variable speed of movement between successive frames, and wherein the adjusting of the preview further comprises:
maintaining, between the successive frames of the preview, a smooth movement for the region of interest at or near the center of the zoomed portion.

16. The method of claim 1, wherein the motion trajectory for the region of interest is indicative of a near constant speed of movement between successive frames, and wherein the adjusting of the preview of the image further comprises:
locking, between the successive frames of the preview, a position for the region of interest at or near the center of the zoomed portion.

17. The method of claim 1, wherein the determining of the region of interest further comprises:
receiving a user indication of the region of interest.

18. The method of claim 1, wherein the determining of the region of interest further comprises:
determining, based on a neural network, a saliency map indicative of the region of interest.

19. The method of claim 1, further comprising:
determining that the adjusted preview is at a magnification ratio that is below a threshold magnification ratio; and
transitioning from the zoomed mode of operation to the normal mode of operation.

20. The method of claim 1, wherein the region of interest comprises a human face, and wherein the determining of the region of interest is based on a face detection algorithm.

21. A mobile device, comprising:
an image capturing device comprising a display screen;
one or more processors; and
data storage, wherein the data storage has stored thereon computer-executable instructions that, when executed by the one or more processors, cause the mobile device to carry out functions comprising:
displaying, by the display screen of the image capturing device, a preview of an image representing a field of view of the image capturing device;
determining a region of interest in the preview of the image;
transitioning the image capturing device from a normal mode of operation to a zoomed mode of operation, wherein the zoomed mode of operation comprises:
determining, based on sensor data collected by a sensor associated with the image capturing device, a motion trajectory for the region of interest, and
based on the determined motion trajectory, generating an adjusted preview representing a zoomed portion of the field of view, wherein the adjusted preview displays the region of interest at or near a center of the zoomed portion; and
providing, by the display screen, the adjusted preview of the portion of the field of view.

22. A non-transitory computer-readable medium comprising program instructions executable by one or more processors to cause the one or more processors to perform operations comprising:
displaying, by a display screen of an image capturing device, a preview of an image representing a field of view of the image capturing device;
determining a region of interest in the preview of the image;
transitioning the image capturing device from a normal mode of operation to a zoomed mode of operation, wherein the zoomed mode of operation comprises:
determining, based on sensor data collected by a sensor associated with the image capturing device, a motion trajectory for the region of interest, and
based on the determined motion trajectory, generating an adjusted preview representing a zoomed portion of the field of view, wherein the adjusted preview displays the region of interest at or near a center of the zoomed portion; and
providing, by the display screen, the adjusted preview of the portion of the field of view.
